(19) United States
(12) Patent Application Publication
(10) Pub. No.: US 2010/0064831 A1
(43) Pub. Date: Mar. 18, 2010

(54) INFINITELY VARIABLE TRANSMISSION WITH HYBRID ACCELERATOR

(76) Inventors: Gary D. Lee, Spanish Fork, UT (US); William M. Decker, Salt Lake City, UT (US); Brandon Levi Haupt, Malta, NY (US); Isaac Reo Jones, Provo, UT (US); Robert H. Todd, Provo, UT (US); Carl D. Sorensen, Provo, UT (US); Kenneth W. Chase, Orem, UT (US)

Correspondence Address: Workman Nydegger;1000 Eagle Gate Tower, 60 East South Temple, Salt Lake City, UT, 84111, US

(21) Appl. No.: 12/559,421

(22) Filed: Sep. 14, 2009

Related U.S. Application Data
(60) Provisional application No. 61/192,090, filed on Sep. 15, 2008.
(60) Provisional application No. 61/195,457, filed on Oct. 6, 2008.
(60) Provisional application No. 61/240,646, filed on Sep. 8, 2009.

(51) Int. Cl. F16H 37/16; F16H 59/02; F16H 55/08

(52) U.S. Cl. 74/22 R; 74/335; 74/457

(57) ABSTRACT

Disclosed are systems, assemblies, and components that relate to power transfer. In particular, the disclosed systems includes a transmission that offers variable speeds and changes between different gear ratios while maintaining constant engagement. Constant engagement may be maintained by tooth-to-tooth contact to be scalable for a variety of applications. An example system includes a phase shifting mechanism. The phase shifting mechanism may include an eccentric gear that provides an oscillating output. The oscillating output creates an overall gear ratio change that slides between gear ratios, thereby allowing changes to occur in small, and possibly infinitely small increments. According to one example, an eccentric gear has a changing base radius and includes a tooth with a hybrid profile that has a base the width of an initial profile, and a width at a top of the tooth that is that of a final profile.

### CROSS REFERENCE TO RELATED APPLICATIONS

This application claims the benefit of, and priority to: U.S. Application Ser. No. 61/192,090, filed on Sep. 15, 2008 and entitled “CONCEPTUAL DESIGN AND ANALYSIS OF A POSITIVELY ENGAGED CONTINUOUSLY VARIABLE TRANSMISSION;” U.S. Application Ser. No. 61/195,457, filed on Oct. 6, 2008 and entitled “CONCEPTUAL DESIGN AND ANALYSIS OF A POSITIVELY ENGAGED CONTINUOUSLY VARIABLE TRANSMISSION;” and U.S. Application Ser. No. 61/240,646, filed on Sep. 8, 2009 and entitled “REVERSE DIFFERENTIAL WITH ENGAGED NEUTRAL.” Each of the foregoing applications is hereby incorporated, by this reference, in its entirety.

### BACKGROUND OF THE INVENTION

1. The Field of the Invention

The present application relates to the field of power transmission. More particularly, embodiments within the scope of the present application relate to, among other things, methods, systems, sub-systems, assemblies, and components for providing constant engagement during power transmission, and during changes of gear ratios in very small, and possibly infinitely small, increments.

2. Related Technology

Since the advent of mechanical engines, primary design considerations have been focused, to at least some degree, on allowing a small engine to move a relatively larger load. Further, as engines evolved and the technology associated with them became increasingly more sophisticated, engines were developed having transmissions with multiple ratios to allow the engine to start moving the load with a low ratio and to incrementally step up to increasingly higher ratios as the load began to move. In such a manner, a transmission could make effective use of the power and torque provided by the engine, and could keep the engine operating near an appropriate speed.

Variable speed transmissions thus provided an engine with the ability to operate within a narrow range of speeds while providing a wider range of output speeds. However, an operating constraint of such variable speed transmission had long been the inability of the transmission to couple a power source to a load while continuing to deliver an efficient output over a large range of gear ratios. In particular, such transmissions typically provided fixed, discrete gear ratios, and while some level of efficiency could be obtained by changing gear ratios, each discrete gear ratio provided optimum efficiency at only a limited range of input speeds. Such efficiency could be measured either in terms of power output or fuel economy.

To effect an incremental change in gear ratio, a manual transmission uses various separate driven gears of different sizes in connection with one or more drive gears. As a gear ratio change is made, a drive gear disengages from the driven gear and re-engages with a different driven gear. For example, a clutch may cause a drive gear to be disengaged from a driven gear and then to re-engage the same or a different drive gear with a second driven gear having a different radius. As the newly engaged gears have different radii, the gear ratio is changed. To effect this gear ratio change, however, the drive gear must be temporarily disconnected from all driven gears, such that the power source is also temporarily disconnected from the load while the gear ratio change is made.

Automatic transmissions also make incremental changes in gear ratio by disconnecting the engine from the load. To do so, automatic transmissions typically use one or more planetary gear sets which are used in connection with a series of clutches and bands that are driven by a hydraulic system. To change between gear ratios, valves within the hydraulic system are used to control hydraulic pressure which activates various clutches and bands so as to connect and disconnect the carriers and various gears of the automatic transmission from the engine. Based on the specific clutches and bands that engage and disengage, the transmission achieves a predetermined gear ratio change. Automatic transmissions can shorten and automate the duration of a disengagement between drive and driven gears, but there remains a period of time in which disengagement occurs, and during which the load is disconnected from the power source.

When the power source is disconnected or disengaged from the load, the engine coasts until the power source is reconnected to the load. As the engine coasts, however, the moving load begins to lose momentum. The loss of momentum can be particularly noticeable and detrimental when the effective load increases, such as when the load is moving uphill or even on relatively level ground. In any event, however, the loss of momentum during disengagement results in an inefficient use of the engine horsepower and fuel. In still other applications, it is impractical to disconnect the load from the power source, which makes the described manual and automatic transmissions unworkable. For example, an elevator may be unable to take advantage of the benefits of certain variable speed transmissions because causing the elevator carriage to coast during ascent or decent could make the elevator unsafe for passengers.

The automotive and numerous other industries that either rely upon transmissions to provide a range of gear ratios, or that would benefit from transmissions that provide a range of gear ratios, have thus long sought to find a transmission that can maintain a constant connection between a power source and a load. Further still, because typical transmissions operate with only a small group of discrete gear ratios—each one having only one or very few speeds at which the engine operates at optimum efficiency—the engine operates mostly in an inefficient range. Thus, industry has also long sought a transmission that will deliver an output at peak engine efficiency, and do so over a large range of gear ratios. With increased efficiency provided by the transmission, horsepower requirements of the motor can be reduced, thereby providing a lighter engine with higher output and/or increased fuel economy.

In low torque applications, attempts have been made to address the problems associated with disconnecting the power source from the load and having only a few, fixed gear ratios, through the use of continuously variable transmissions (CVT). A CVT typically uses two pulleys which are connected by a frictional belt. The pulleys can include two cones that face each other and which can be pulled together or pushed further apart by some mechanism. As one pulley increases its radius, the other pulley decreases its radius to keep the frictional belt tight. As the two pulleys change their radii relative to one another, they create various gear ratios. A similar concept that may also be considered a CVT also makes use of similar, complementary pulleys and cones. Instead of a frictional belt, however, the CVT uses a frictional rolling member that is sandwiched between the cones.

Regardless of whether a frictional belt or rolling member is used, however, such CVT systems generally rely on friction to facilitate adjustment of gear ratios and provide power output. Within a friction-based system, there are various inefficiencies. For example, there may be slippage between the pulleys and frictional belt, or between the frictional rolling member and cones, which can reduce power output, at least for a time. Additionally, or alternatively, friction in the system can result in the generation of heat, however, and, as a result, the wrapping member or rolling member heats up and is increasingly susceptible to wear damage, thereby requiring that the user repair or replace the parts. To reduce the frequency of repair, the frictional wrapping or rolling members can be toughened, such as through the use of a thicker belt or impregnation of the belt with metals or other tougher materials. However, as the belt strength is increased, the part costs increase. Moreover, insufficiently tough materials can cause the cones within the transmission to wear and fail.

Moreover, because these CVT systems rely largely, if not solely, on the use of friction to transmit energy between components, they are typically only suitable for low torque applications, as high torque applications could cause excessive heating within the transmission, thereby causing even greater wear and failure of the transmission components. As a result, CVT transmissions are not scalable for a wide variety of applications that may require low and high torque, and thus have a fixed, and relatively small, range of useful applications.

Further, because the CVT systems have been seen as unacceptable alternatives in high-torque applications, additional efforts have been made within high-torque applications in an attempt to provide little to no time gap between disconnection and reconnection of the power source and load. In one application, clutching and reconnection are automated so that there may be no real time gap or torque loss, but such comes at the expense of a significantly increased complexity and transmission size, which also makes it cost prohibitive for certain applications, and non-scalable for low torque or small applications.

### BRIEF SUMMARY OF SOME EXAMPLE EMBODIMENTS

Example embodiments described in this application relate to transmissions capable of operating over a large, possibly infinite, number of gear ratios. More specifically, example embodiments relate to systems, assemblies, and components that can be used to provide constant, positive engagement at discrete gear ratios and during changes between different gear ratios.

In at least some example embodiments, a transmission, clutch, or other power transfer system that includes a power input mechanism and a phase shifting mechanism coupled to the power input mechanism. The phase shifting mechanism in such an example embodiment can also have at least two members configured to provide reciprocating inputs. A combiner may also be included that is configured to combine the at least two reciprocating inputs into an aggregate output. A power transfer system may also included an output system coupled to a phase shifting mechanism, an configured and arranged to receive the aggregate output from the phase shifting mechanism.

In some example embodiments, that at least two reciprocating inputs optionally include at least one eccentric gear. For example, each of the two members that are configured to provide reciprocating inputs may be an eccentric gear. An eccentric gear may also optionally have one or more teeth that have a hybrid involute profile. For example, a hybrid involute profile may be used on an example eccentric gear that has a varying base circle radius. The hybrid involute tooth profile may be any suitable hybrid profile, including a profile described by equations 92 and 93 in the Appendix section herein.

An example eccentric gear can have teeth profiles based on a number of considerations. For example, an initial profile may be considered that corresponds to a first base circle radius. Additionally, or alternatively, a final profile may be considered that corresponds to a second base circle radius that is optionally different than the first base circle radius.

In any example power transfer system that includes an optional phase shifting mechanism, the phase shifting mechanism can include at least one variable phase component. A variable phase component can, for example, be connected to a combiner and/or reciprocating input mechanisms and may also change a reciprocating input received from a reciprocating input. For example, the phase component may chance a phase of a reciprocating input. Also, a combiner may change an amplitude of an aggregate output based at least in part on phase considerations of two reciprocating inputs. In some cases, a power transfer system may include two phase shifting mechanisms, such that each include two reciprocating inputs, and with each having a combiner that combines two reciprocating outputs into an aggregate output.

An example embodiment of a power transfer system can also include an output. In some examples, the output system includes first and second drive shafts that have respective first and second gears disposed thereon. An output shaft may also be included that has one or more driven or driveable gears. The first and second gears may, relative to the driveable gears, also define different respective gear ratios. More than two gears may also be included. For example, there may be multiple gears on a single shaft. Optionally, only one of those gears is in mesh with a driven or driveable gear. In other example embodiments, only one of those gears is engaged and driving the driveable gear, despite other gears being in mesh with the driveable gear.

An example power transfer system may also include a synchronization mechanism. A synchronization mechanism may, for example, adjust a speed of multiple drive shafts. An example synchronization mechanism may also selectively engage a first drive gear at a first ratio, and a second drive gear at a second ratio. The synchronization mechanism may also cause the first and second gears to be engaged at a third ratio between the first and second ratios.

Another power transfer mechanism may include a reverse differential. A reverse differential may be within a phase shifting mechanism and/or connected to a power input mechanism as well as an output system of a power transfer system. For example, a reverse differential may be configured to combine an input from a power input mechanism with an output from an output system to produce a final output. A final output under one or more combinations of the input and output powers may be an engaged neutral. In an engaged neutral the input may be offset by the output from the output system, and the final output may have approximately zero rotation. Zero rotation may also be obtained despite the input and output both providing power, but with power substantially fully offsetting each other.

In another example embodiment, a power transfer system includes an input mechanism and an output with one or more driveable gears. A gear selection mechanism may be coupled to the input and output, and can be disposed between the input and output. An example gear selection mechanism optionally includes a plurality of drive gears that are configured to engage one or more driven gears of an output. The one or more drive gears may be substantially coaxial, and can also optionally be in constant mesh with the one or more driven gears. A gear selector can then cause a single one of the plurality of drive gears to selectively engage the one or more driveable gears. An unengaged drive gear may nonetheless be in mesh with a driveable gear, but may convey little to no power to the driveable gear.

An example power transfer system may also include a gear selector with one or more balls that are internal to a plurality of drive gears. One or more pockets may be formed on the plurality of drive gears and can correspond to engage one or more corresponding balls.

In another example power transfer system, a plurality of drive gears are on a common drive shaft. A gear selector may be configured to cause a single one of the drive gears to selectively engage one or more driveable gears by way of a mechanism that is internal to the drive shaft and the single one of the plurality of drive gears. Optionally, an internal mechanism includes a trap shaft with one or more balls that can engage one or more drive gears. To facilitate engagement of the balls, a channel may be formed in a trap shaft or other housing for the balls. The channel can house a fluid that is pressurized by a pressurization mechanism. When pressurized, the fluid can exert a force to cause balls to selectively engage only one of a plurality of drive gears. Optionally, a gear selector has a rotatable shaft that is configured to selectively engage a single drive gear disposed on that shaft. Any rotational position of the shaft may be such that any rotational position can engage at most one of the plurality of gears. The shaft may be a collar or a trap shaft.

According to another embodiment, a gear is disclosed that has a gear body and a plurality of teeth disposed around at least a portion of the gear body. At least two teeth of the gear may also have different respective profiles. For example, the at least two teeth with different profiles may include a first tooth with a profile corresponding to at least a first base circle radius, as well as a second tooth with a profile corresponding to a second base circle radius that is different than the first base circle radius. The first and second base circle radii may each be a set or array of different base circle radii that are different. In some cases, a gear tooth may have a hybrid involute profile. A hybrid involute profile may, for example, have a base width corresponding to an initial profile of a first base circle radius. A top width may correspond to a final profile of a second base radius that is different than the first base circle radius.

This summary is provided to introduce a selection of concepts in a simplified form that are further described below in the detailed description of some example embodiments. This summary is not intended to identify key features or essential features of the claimed or described subject matter, nor is it intended to be used as an aid in determining the scope of the claimed subject matter.

Additional features and advantages of the example embodiments will be set forth in the description which follows, and in part will be obvious from the description, or may be learned by practice of the disclosed example embodiments. The features and advantages of the invention may be realized and obtained by means of the instruments and combinations particularly pointed out in the description and in the appended claims.

### BRIEF DESCRIPTION OF THE DRAWINGS

To further clarify the aspects of embodiments of the present invention, a more particular description of the invention briefly described above will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A is a perspective view of an example infinitely variable transmission according to one embodiment of the present invention, and in which input power is carried through a phase shifting assembly and to an output assembly, and ultimately to a reverse differential;

FIG. 1B is a side view of the example infinitely variable transmission of FIG. 1A;

FIG. 2A is side view of an example phase shifting assembly according to one embodiment of the present invention, and which uses a hybrid accelerator to provide a range of gear ratios between each discrete ratio provided by the output assembly in FIG. 1A;

FIG. 2B is a side view of various internal components of the phase shifting assembly of FIG. 2A;

FIG. 2C is a perspective view of a hybrid accelerator within the phase shifting assembly of FIG. 2A, and which includes a cam follower for varying frequency and amplitude of an output;

FIG. 2D is a frontal view of the hybrid accelerator of FIG. 2C, and illustrates an eccentric axis;

FIG. 3A illustrates a comparison of a hybrid involute curve profile to standard involute curve profiles calculated at initial and final positions;

FIG. 3B illustrates an eccentric gear with exaggerated geometry, and having teeth with different profile shapes;

FIG. 4A illustrates a perspective view of an example output system according to one embodiment of the present invention, and that uses a driven output gear mating with two drive shafts that each have multiple drive gears, and which relate to the driven output gear according to fixed, discrete gear ratios;

FIG. 4B is a side view of the output system of FIG. 4A;

FIG. 5A illustrates a side view of a ball selector on a drive shaft such as that illustrated in FIG. 4A, and which can selectively engage one of the multiple driven gears on the drive shaft;

FIG. 5B is a side view of the ball selector of FIG. 5A with a collar removed to expose internal components;

FIG. 5C illustrates a perspective view of a drive gear suitable for use with the draft shaft in FIG. 5A, and which can be selectively engaged by the ball selector;

FIG. 6A illustrates a side, perspective view of an example embodiment of components of a reverse differential system;

FIG. 6B illustrates an enlarged, frontal view of reverse differential gears within the reverse differential system illustrated in FIG. 6A, and which can be used to allow two outputs to combine into a single output; and

FIG. 6C illustrates an enlarged, side view of the reverse differential gears in FIG. 6B.

### DETAILED DESCRIPTION OF SOME EXAMPLE EMBODIMENTS

This description relates to transmission systems. More particularly, implementations of some example embodiments of the present invention extend to transmission systems, assemblies and components that can be used to convey power from a source to a load using various different gear ratios, including gear ratios that in some embodiments are changeable in very small, perhaps infinitely small, increments. More particularly still, implementations of some example embodiments of the present invention relate to transmission systems that are scalable and usable in connection with any of a variety of different technologies, and which can provide peak efficiency over a large range of gear ratios. Additionally, the description includes example embodiments that relate to a transmission that may operate with an engaged neutral so as to allow the transmission to remain engaged while moving from neutral in very small, and perhaps infinitely small, increments either in forward or reverse directions.

Reference will now be made to the drawings to describe various aspects of example embodiments of the invention. It is to be understood that the drawings are diagrammatic and schematic representations of such example embodiments, and are not limiting of the present invention. Moreover, while various drawings are provided at a scale that is considered functional for some embodiments, the drawings are not necessarily drawn to scale for all contemplated embodiments. No inference should therefore be drawn from the drawings as to any required scale.

In the following description, numerous specific details are set forth in order to provide a thorough understanding of the present invention. It will be obvious, however, to one skilled in the art that the present invention may be practiced without a these specific details. In other instances, well-known aspects of transmission systems, including, by way of example, bearings, journals, manufacturing processes, and the like have not been described in particular detail in order to avoid unnecessarily obscuring aspects of the disclosed embodiments.

As set forth below, various terms are used in this disclosure. The use of such terms is made with the recognition and understanding that these and other terms employed herein do not constitute the sole manner in which a particular idea, concept or aspect may be expressed or embodied.

As used herein, the phrase “constant engagement” embraces substantially continuous engagement between at least one drive member and at least one driven member, and which may be used in effecting changes to the overall gear ratio of a transmission system. Stated another way, in a constantly engaged transmission, two or more drive and driven members (e.g., two gears or one chain and one sprocket), remain engaged and in mesh. Moreover, such engagement in transmissions described herein can embrace constant engagement through a gear ratio change, in which constant engagement and meshing is maintained between at least one drive member and at least one driven member while a gear ratio change is made. In such a case, constant engagement does not necessarily require that the same drive and driven members remain engaged during the gear ratio change, but contemplates that engagement and mesh is maintained by keeping multiple drive and/or driven members engaged, and without disconnecting the source from the load. Where constant engagement is maintained between drive and driven members made of metals, alloys, and the like, such that there is constant metal-to-metal engagement, the constant engagement may be referred to herein as “positive displacement.”

The phrase “continuously variable transmission” or “CVT” is also used herein to describe a transmission capable of operating at a plurality of gear ratios, and in which the plurality of gear ratios are changeable in very small, possibly infinitely small, increments over a range of gear ratios. Where the range of gear ratios from which the transmission can move in very small, possibly infinitely small, ratios includes zero output, the CVT may be referred to herein as an “infinitely variable transmission” or “IVT.” In essence, a CVT or IVT can effectively slide between ratios, but a CVT can operate over any type of range, whereas an IVT can operate over a range, but that range also includes a neutral state from which the transmission can slide to other ratios.

Reference will now be made to the figures to disclose various aspects of example embodiments of the invention. It is understood that the figures are diagrammatic and schematic representations of such example embodiments, and are not limiting of the present invention, nor are they necessarily drawn to scale. No inference should therefore be drawn from the figures as to the dimensions of any invention or element, or as to the necessity of including any particular element.

### 1. General Transmission System

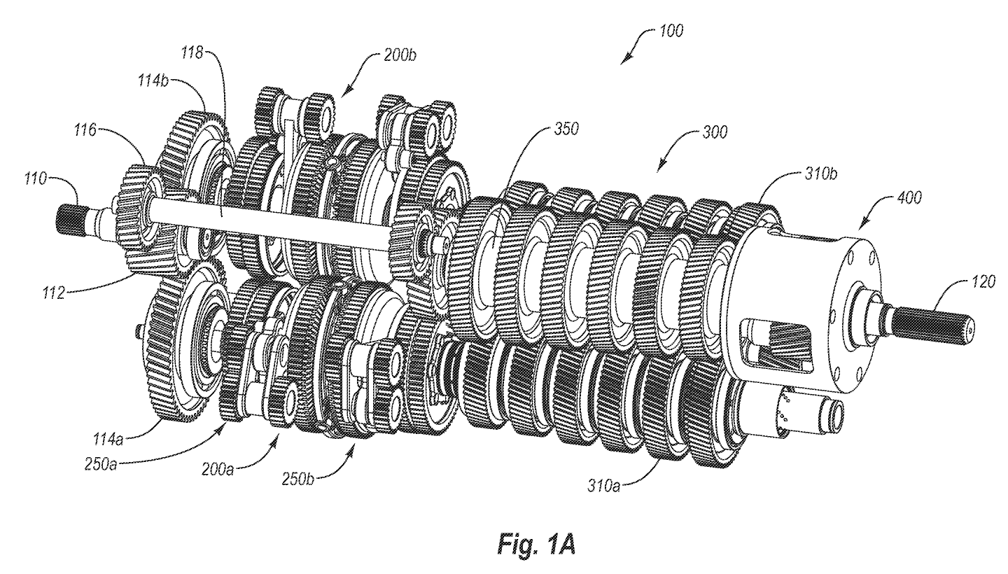

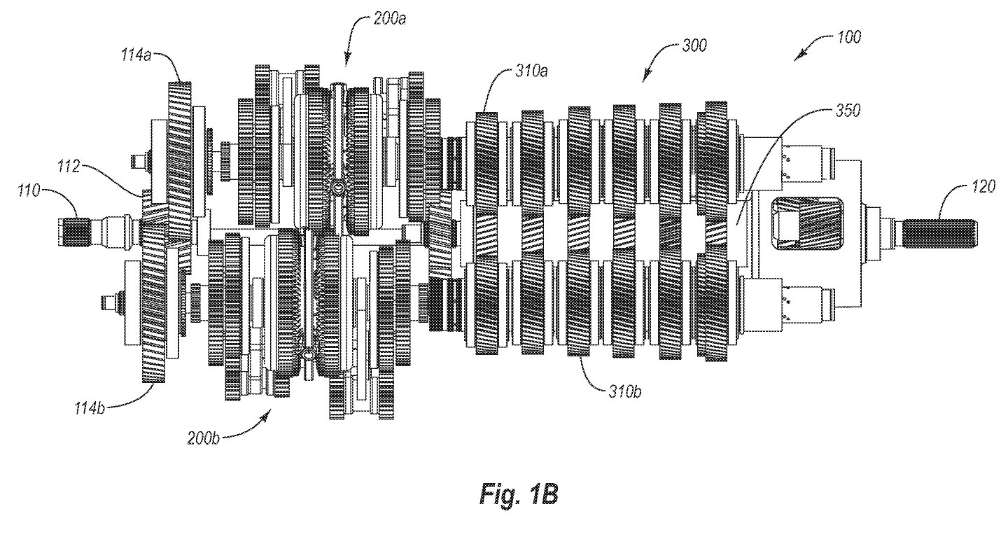

With reference to FIGS. 1A and 1B, an example transmission 100 is illustrated according to one embodiment of the present invention. It should be appreciated that transmission 100 is illustrative in all respects, and that particular features and/or components of transmission 100 are merely optional unless explicitly recited as being required or necessary for operation.

In the illustrated embodiment, various assemblies and components operate together to provide a transmission that will provide constant engagement and positive displacement over a wide range of gear ratios, as well as during changes in gear ratios, with such changes being made in very small, and possibly infinitely small, increments. In the example transmission 100, a first end of transmission 100 includes a transmission input 110 through which a rotational input is supplied from a power source. The power source may be a turbine engine, internal combustion engine, electric motor, or any other power system capable of providing an input that is rotational or which can be converted to a rotational input.

As the power is received at transmission input 100, an input shaft rotates. Such an input shaft may be connected to a splitting gear 112 as shown in FIGS. 1A and 1B, although such is merely exemplary and need not be the case for all embodiments in accordance with the present invention. In the illustrated example embodiment, splitting gear 112 rotates at the same rotational speed as transmission input 110 and transfers power and torque through three different torque paths. In particular, a first torque path begins as splitting gear 112 engages a first differential output drive gear 114a, which connects to a first phase shifting assembly 114a that includes a differential as described hereafter. A second torque path similarly begins as splitting gear 112 engages a second differential output drive gear 114b, which connects to a second phase shifting assembly 114a that may also include a differential therein. A third torque path may be provided as splitting gear 112 engages a first transfer gear 116 connected to a transfer shaft 118. As splitting gear 112 rotates, transfer gear 116 and transfer shaft 118 each receive a corresponding rotation. Transfer shaft 118 may also have a second transfer gear 120 connected thereto. As second transfer gear 120 rotates due to the rotation of transfer shaft 118, second transfer gear 120 can cause a differential linking gear 404 to rotate. Such rotation of differential linking gear 404 may rotate as a result of being directly engaged by second transfer gear 120, or as a result of being linked to second transfer gear 120 in another manner. For example, in one embodiment, second transfer gear 120 is linked to differential linking gear 404 by way of one or more other, intermediate gears.

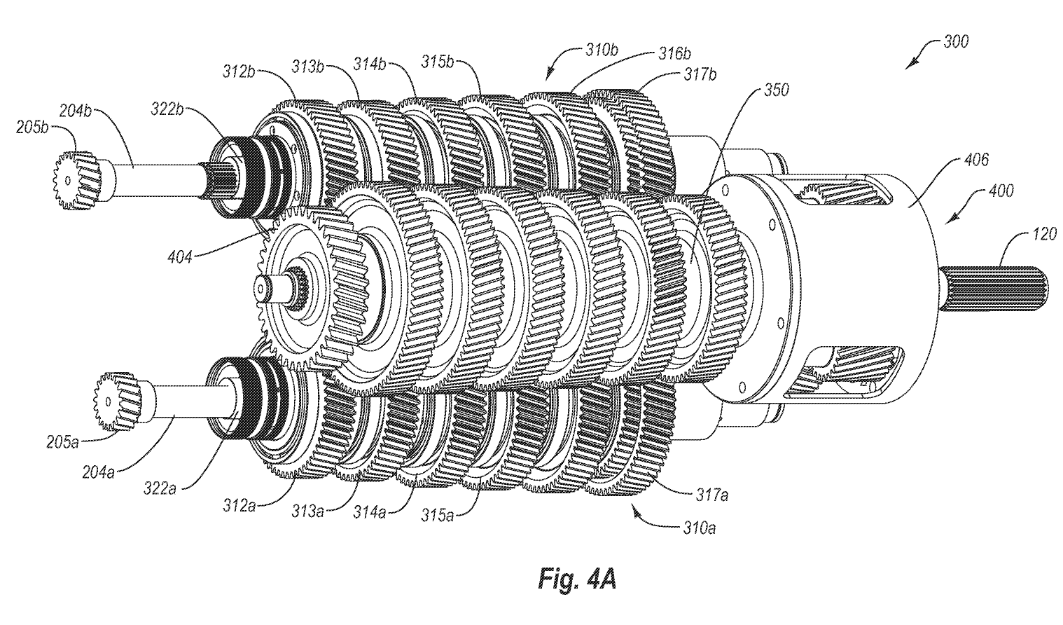

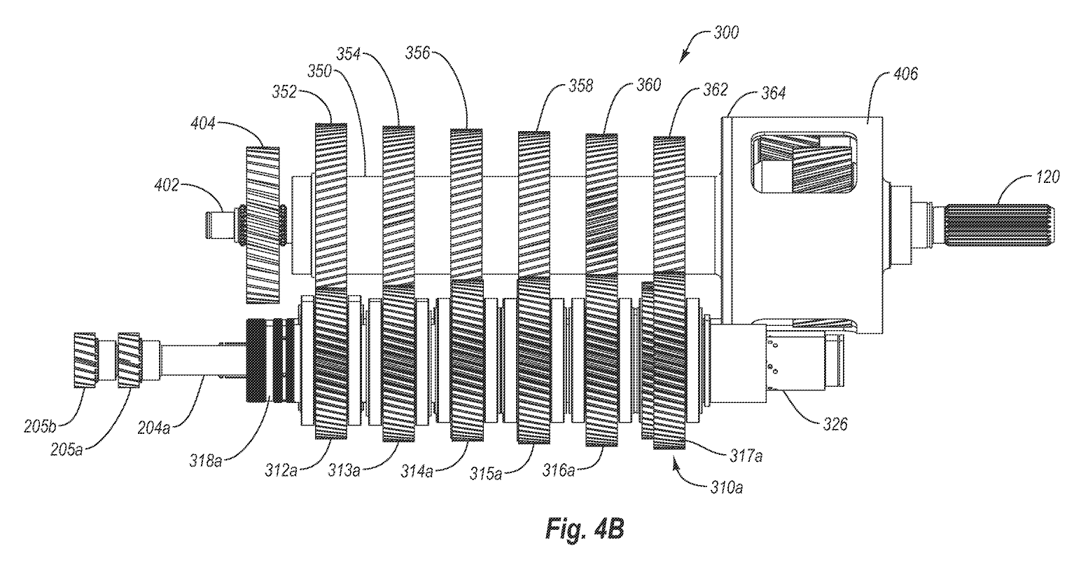

The torque path through splitting gear 112 to differential linking gear 404 can, in some embodiments, bypass phase shifting assemblies 200a, 200b as well as possibly output system 300. For instance, in the illustrated embodiment, differential linking gear 404 may be connected to a differential input shaft 402 (FIG. 4B) that passes directly through a transmission output system 300 and provides an input to a reverse differential system 400.

Output system 300, phase shifting systems 200a, 200b and reverse differential system 400 will each be described in greater detail hereafter, along with the interactions between each. In general, however, the three torque paths that start at splitting gear 112 all facilitate different features and aspects of transmission 100. For example, by splitting the torque in the above manner, transmission 100 is able to provide a continuously variable transmission system with constant engagement and positive displacement, and such that the constant engagement is maintained not only at discrete ratios provided by output system 300, but also during gear ratio changes and at gear ratios between the discrete ratios of output system 300. Such may be provided by, for example, the interaction between phase shifting assemblies 200a, 200b as described herein.

Moreover, the multiple torque paths in the embodiment of transmission 100 in FIGS. 1A and 1B may also provide an ability to not only operate as a continuously variable transmission, but also as an infinitely variable transmission. That is, transmission 100 can operate along a continuous range of ratios, and such range may also include a ratio at which transmission output 120 provides zero output, even while there is a constant connection between the power source providing input to transmission input 110 and the load driven by transmission output 120. Indeed, transmission 100 can, in some example embodiments, provide very small, and possibly infinitely small, gear ratio changes in forward and/or reverse directions directly out of neutral, all while maintaining constant engagement between the power source and the load.

It should also be appreciated that while automotive systems are disclosed herein, the scope of the invention is not so limited. In fact, transmission 100 is suitable for use in virtually any application where power is required to be transferred to a load, and can be scalable for use in low and high torque conditions. For instance, the application may include a vehicle such as a passenger car or truck, a bus, a military vehicle, mass transport device, a transport vehicle such as a semi-tractor trailer, and marine applications such as ship and boat propulsion systems. Other embodiments of transmission 100 may be implemented in farm equipment, or with power sources such as windmills or hydroelectric dams. Accordingly, virtually any type of power source that can be used to generate a rotational output and which would benefit from a change in gear ratios, can be used in connection with embodiments of the present invention.

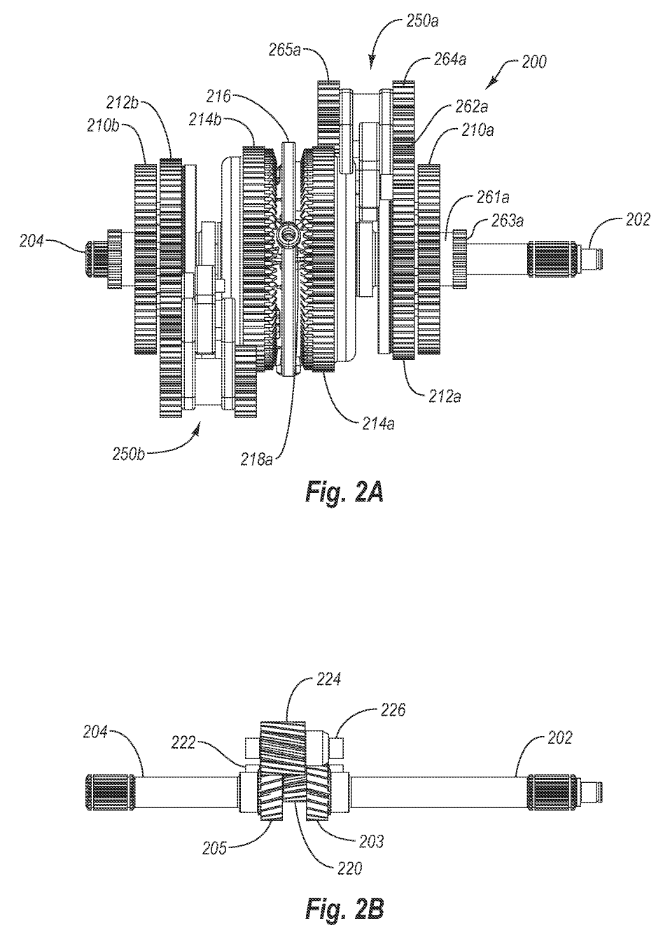

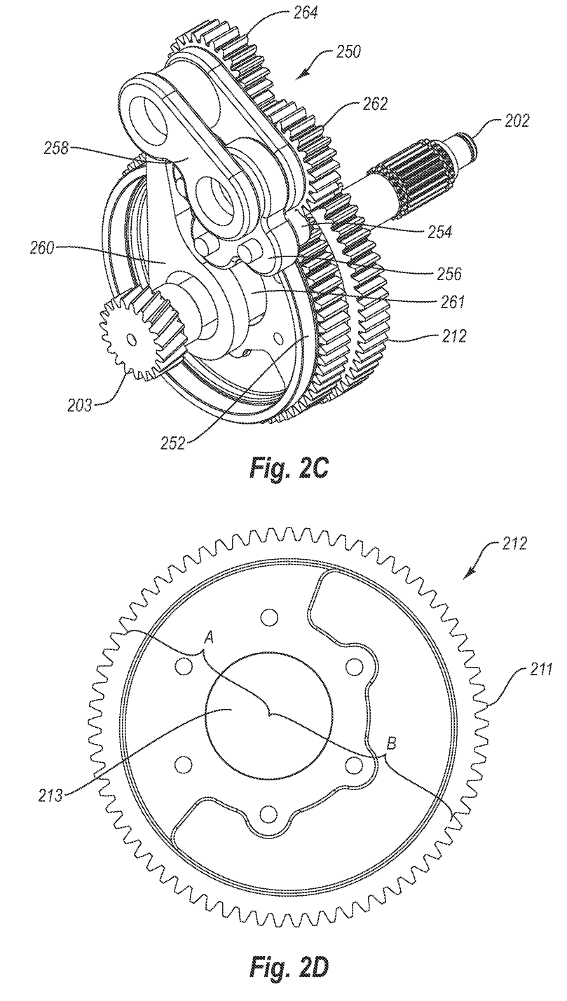

A brief description of the overall operation of transmission 100 in FIGS. 1A and 1B will be provided. It should be appreciated, however, that various assemblies and components of transmission 100 are illustrated and described in FIGS. 2A-6C. Accordingly, the description relative to FIGS. 1A and 1B is intended to provide a general overview of selected aspects of the operation of transmission 100, while more particular details of the various components and assemblies, and the interactions therebetween, are discussed hereafter.

As noted previously, as power is received through transmission input 110, that power may be transferred to, and through, phase shifting assemblies 200a, 200b by, for example, using splitting gear 112 to engage differential output drive gears 114a, 114b. Differential output drive gears 114a, 114b can, in the example embodiment in FIGS. 1A and 1B, each be connected to a shaft that connects to a respective phase shifting assembly 200a, 200b. For example, power input through transmission input 102, may be directed to first differential output gear 114a, and from there transferred by a shaft into phase shifting assembly 200a.

In the example embodiment in FIGS. 1A and 1B, phase shifting assembly 200a can be used to selectively affect the power input from first differential output gear 114a. In particular, the received power in phase shifting assembly 200a can be passed through phase shifting assembly 200a, or it may be modified in some manner, such as is described hereafter. For instance, in one embodiment, such as when transmission 100 is running at a particular gear ratio, it may be desirable to operate transmission 100 at a constant speed. In such a case, phase shifting assembly 200a may essentially be selectively deactivated such that received power passes through phase shifting assembly 200a, and into drive shaft 310a of output assembly 300. The power on drive shaft 310a can be used to drive a main output gear 350 of output assembly, and drive shaft 310a may operate at a particular gear ratio with respect to main output gear 350.

Main output gear 350 may then provide an output directly to transmission output 120, or may pass such output through an optional reverse differential assembly 400. In some cases, reverse differential assembly may receive two inputs—such as from transmission input 110 and from main output gear 350, and combine them for an output. In such manner, the combined output may produce reverse, neutral, drive and/or overdrive gears.

At other times, phase shifting assembly 200a may be selectively activated. For example, a particular gear on drive shaft 310a may operate at a fixed gear ratio relative to main output gear 350. If, however, it is desired to provide a different overall transmission gear ratio, phase shifting assembly 200a can be activated to modify the input, thereby also modifying the gear ratio of transmission 100.

For example, phase shifting assembly 200a includes a set of hybrid accelerator gears 212a, 212b. These gears may have an eccentric or other non-standard profile. In one example, disclosed in further detail below, a hybrid accelerator gear is non-circular in shape, is a gear with a changing base circle and/or pitch circle radius, and/or includes at least one gear tooth whose geometry is different from a geometry of at least one other tooth of the hybrid accelerator gear. In any case, and due to the eccentricity or other non-standard profile of hybrid accelerator gears 212a, 212b, follower gears that mesh with hybrid accelerators 212a, 212b may experience accelerations and/or decelerations. The accelerations and/or decelerations can be combined with the pass-through shaft to vary the output provided to drive shaft 310a. A particular example of how the accelerations and/or decelerations can be added to a pass-through shaft is discussed in more detail with respect to FIGS. 2A-2B, although any suitable mechanism may be used.

Additionally, by selectively engaging phase shifting assemblies 200a, a gear ratio change within output assembly 300 may be performed seamlessly, so that constant engagement is maintained. In particular, main output shaft 350 may progress from one drive gear (e.g., a drive gear on drive shaft 310a) to a next drive gear in a sequence (e.g., a drive gear on drive shaft 310b), while at least one of the drive gears is driving main output gear 350 at all times, so that there is no disconnection between the power source and the load.

For instance, while a gear on drive shaft 310a is being used to drive main output gear 350, it may be desirable to change to a gear ratio provided by a gear on drive shaft 310b. The two drive gears may have different ratios relative to main output gear 350, which could prevent simultaneous engagement in standard transmissions. In the example embodiment of transmission 100 in FIGS. 1A and 1B, however, drive gears on drive shafts 310a, 310b may nonetheless both engage main output shaft 350 despite the difference in gear ratios.

By way of illustration and not limitation, power received at transmission input 110 and transmitted along torque paths that include both phase shifting assemblies 200a, 200b, can ultimately be used to drive both of drive shafts 310a, 310b. If phase shifting assemblies 200a, 200b are effectively disengaged to merely pass-through the power, the input at drive shafts 310a and 310b may prevent gears of different ratios from simultaneously engaging main output 350. If, however, one or both of phase shifting assemblies 200a, 200b is selectively activated, the power transmitted to drive shafts 310a, 310b may be independently modified. As a result, phase shifting assemblies 200a, 200b can harmonize the speeds of drive shafts 310a, 310b so that they rotate at different speeds, thereby allowing gears of different ratios to be simultaneously engaged with the same main output gear 350.

The output provided by main output gear 350 may then be provided to transmission output 120. Such power may be conveyed directly to transmission output 120 or, as illustrated in FIGS. 1A and 1B may run through one or more other components. For instance, transmission 100 includes a reverse differential system 400. As described in more detail herein, reverse differential system 400 can use the output of main output gear 350 as an input, and also use a second input which optionally comes from transmission input 110, but could also come from another source. The two inputs can be combined before ultimately being conveyed as a single output to transmission output 120. Based on the magnitudes and directions of the two inputs, reverse differential system 400 may provide reverse, neutral, drive, and/or overdrive speeds.

As will be appreciated from the foregoing description, a variety of components, assemblies, systems and/or sub-systems may be combined to provide power transmission such as in the example embodiment of transmission 100 in FIGS. 1A and 1B. While presented by way of illustration and not limitation, such components may include one or more phase shifting assemblies, one or more hybrid accelerators, one or more drive shafts, and one or more differential systems. These and other components, assemblies, systems, and sub-systems are each discussed in more detail below.

### 2. Phase Shifter

As discussed above, an example embodiment of a transmission may include a phase shifting component, system, and/or assembly. Such a phase shifting component may, for example, be actuated to vary the frequency and/or amplitude of an input in transmitting power to an output system.

Turning now to FIGS. 2A and 2B, example embodiments of a phase shifting assembly 200 are illustrated in greater detail. Phase shifting assembly 200 may include components and features similar to phase shifting assemblies 200a, 200b in FIGS. 1A and 1B, accordingly, the discussion herein related to phase shifting a assembly 200 is equally applicable to phase shifting assemblies 200a, 200b.

As disclosed herein, power received through a transmission input may be conveyed through one or more torque paths in a transmission, and such one or more torque paths may extend through phase shifting assembly 200. Accordingly, in the example embodiment in FIGS. 2A and 2B, for example, phase shifting assembly 200 can operate while under load. In other embodiments, however, a phase shifting assembly 200 may operate without carrying the load.

In this embodiment, input from a transmission is received through a differential input shaft 202. Differential input shaft 202 may then direct the received input through phase shifting assembly 200 in any suitable manner. According to one embodiment, for instance, input shaft 202 may cause the received input to pass-through phase shifting assembly 200 without a phase or amplitude shift. In other embodiments, however, input from differential input shaft 200 may have a frequency and/or amplitude modification caused by phase shifting assembly 200.

In order to understand how the example embodiment of phase shifting assembly 200 can impose a phase and/or amplitude modification on the received input, it is helpful to understand how the same phase shifting assembly 200 can, under some conditions, pass input directly through phase shifting assembly 200 without such phase or amplitude modifications. To appreciate the pass-through features of phase shifting assembly 200a, FIG. 2B illustrates various internal components of the phase shifting assembly 200 of FIG. 2A. In FIG. 2B, various components from FIG. 2A have been removed to expose an internal gear set configured to pass the input through phase shifting assembly 200.

In FIG. 2B, input shaft 202 is connected to an input sun gear 203. As input shaft 202 rotates, input sun gear 203 rotates. Input sun gear 203 is also in mesh with a first idler 220. First idler 220 may rotate on a first idler shaft 222 when first idler rotates. First idler shaft 222 may be secured within a ring housing 216 (FIG. 2A) and may, for example, be connected to ring housing 216 with bearings around shaft 216 that allow first idler shaft 222 to freely rotate about its own longitudinal axis, and within ring housing 216. First idler shaft 222 may be positioned at any location within ring housing 216. However, in one example embodiment, first idler shaft 222 is not centered within ring housing 216 for reasons described hereafter.

First idler 220 may also mesh with a second idler 224. As a result, as first idler 220 is rotated by input sun gear 203, the rotation of first idler can be passed to second idler 224. Second idler 224 may also be connected to a second idler shaft 226. As second idler 224 is caused to rotate, it may rotate around a longitudinal axis of second idler shaft 226. Second idler shaft 226 may also be connected to ring housing 216 by using bearings, for example, and may be centered within ring housing 216, or positioned off-center as described hereafter. In FIG. 2B, second idler 224 is also positioned and configured to mesh with an output sun gear 205 that rotates on a phase shifter output shaft 204.

As will be appreciated by one skilled in the art in view of the disclosure herein, FIG. 2B thus illustrates an interior system within phase shifting assembly 200 by which power received at input 202 can be passed through a set of idlers 220, 222, and ultimately to a phase shifting output shaft 204. Moreover, idlers 220, 222, input shaft 202, and output shaft 204 may each use bearings or journals, or otherwise be fixed within phase shifting assembly 200a in a manner that allows them to freely rotate. Further, such rotation may be permitted to happen independent of other components of phase shifting assembly 200. For instance, rotation of input shaft 202 and/or output shaft 204 may not directly cause ring housing 216 or other components of phase shifting assembly 200 to rotate, thereby allowing power input to phase shifting assembly 200 to pass through without modification, or with the only substantial modification to the input being effected by idlers 220, 224 and sun gears 203, 205, which optionally modify the input using one or more gear ratios.

Understanding that phase shifting assembly 200 can thus receive an input and pass it through phase shifting assembly 200 with little or no modification to the received input, attention will now be paid to additional aspects of phase shifting assembly 200 as illustrated in FIGS. 2A and 2C. Such features can be combined with the pass-through aspects of phase shifting assembly 200 to provide, for example, a selectively variable output that may have a frequency and/or amplitude modification applied to the input, such that the output at phase shifting output shaft 204 is varied.

For instance, in the example embodiment illustrated in FIG. 2A, an eccentric drive gear 210a is positioned on a carrier shaft 261a. In the illustrated example embodiment, input shaft 261a may be a hollow shaft. Indeed, in some embodiments, input shaft 202 may pass through a hollow carrier shaft 261a and optionally be free to rotate within hollow carrier shaft 261a.

Additionally, eccentric drive gear 210a may, in this example embodiment, be free to rotate relative to carrier shaft 261a. For instance, eccentric drive gear 210a may be connected to carrier shaft 261a though use of bearings, and such bearings may allow carrier shaft 261a to rotate without causing eccentric drive gear 210a to rotate, and/or to allow eccentric drive gear 210a to rotate without also requiring that carrier shaft 261a rotate.

As also shown in FIG. 2A, eccentric drive gear 210a can, in some example embodiments, be coupled to an eccentric gear 212a that is at times referred to herein as a hybrid accelerator. Eccentric gear 212a is sometimes referred to herein as a hybrid accelerator inasmuch as eccentric gear 212a can, in some embodiments, have a hybrid tooth profile and/or may be used to accelerate output shaft 204 to reconcile its speed with an additional output shaft within a transmission. Accordingly, phase shifting assemblies 200a, 200b are examples of physical implementations of a means for accelerating an output. In some embodiments, such means for accelerating an output may also accelerate the output with a constant velocity input.

As noted previously, a hybrid tooth profile may be used on the eccentric gear 212a, but may also be used on other gears. Various particular examples of a “hybrid tooth profile” are discussed in more detail hereafter, and generally relate to a tooth profile that does not necessarily satisfy all traditional involutometry equations, but which nonetheless satisfies involutometry principles and laws. For example, as noted hereafter, standard involutometry equations may be based on a fixed base circle radius, while a hybrid tooth profile may take into account a base circle radius that changes throughout the width of a tooth.

In the embodiment in FIG. 2A, and as also may be seen in FIG. 1A, eccentric gear 212a and eccentric drive gear 210a can each be positioned around carrier shaft 261a, but eccentric gear 212a may not be centered thereon. For instance, eccentric gear 212a may not be circular and/or, as shown in FIG. 2D, eccentric gear 212a may have an opening positioned off-center such that as eccentric gear 212a rotates, it produces a reciprocating output.

The example phase shifting assembly 200 may also include a follower 250a that includes an eccentric following gear 262a, and which operates as a mechanism that varies the phase of an output of phase shifting assembly 200. Eccentric following gear 262a is configured to engage eccentric gear 212a and be rotated thereby. Follower 250a may also include an eccentric following gear 262a that engages a follower transfer gear 264a which can rotate on a shaft that also rotates an output ring driving gear 265a within follower 250a. An output ring gear 214a may mesh with output ring driving gear 265a.

As will be appreciated by one skilled in the art in view of the disclosure herein, the described relationship between eccentric drive gear 210a and eccentric gear 212a can thus provide a reciprocating output to output ring gear 214a. For example, eccentric drive gear 210a may be mounted to, or otherwise secured to, eccentric gear 212a. In some manner, as eccentric drive gear 210a is caused to rotate, eccentric gear 212a may also rotate. The eccentric aspects of eccentric gear 212a may then produce a reciprocating output that is transferred to follower 250a. Follower 250a may, through output ring drive gear 265a, for example, then cause the reciprocating motion to be transferred to output ring 214a.

The foregoing description of phase shifting assembly 200 primarily concerns the use of an eccentric drive gear 210a to ultimately cause an output ring gear 214a to rotate. Notably, each of the foregoing components is effectively on the input side of ring housing 216 in FIG. 2A. A similar arrangement can also be provided on the output side of ring housing 216. For example, in the illustrated embodiment, an eccentric drive gear 210b may be connected to an eccentric gear 212b, and eccentric drive gear 210b can cause eccentric gear 212b to rotate. Eccentric gear 212b may also have an eccentric configuration such that as it rotates, it generates a reciprocating output that is transferred through a follower assembly 250b to an output ring 214b.

In FIG. 2A, output rings 214a and 214b are illustrated as being on opposing sides of ring housing 216. Furthermore output rings 214 have a gear profile that can engage a pinion gear 218 attached to ring housing 216. In particular, both output ring 214a and output ring 214b engage one or more pinions 218 spaced around ring housing 216. As will be appreciated, the rotational motions of output ring 214a and output ring 214b can each generate a force that causes pinions 218 to rotate. Further, pinions 218 may be connected to ring housing 216 such that pinions 218 can also travel around output rings 214a, 214b, which causes ring housing 216 to rotate about its central axis.

In effect, pinions 218 operate to combine the rotational motions provided by output rings 214a, 214b. More particularly, pinions 218 are operated by the relative motions of output rings 214a, 214b, and can have two motions. For example, output rings 214a, 214b may have motions that are equal and opposite. In such a circumstance, the relative motions of output rings 214a, 214b may be additive, but the opposing and equal motions cancel each other out, so that no net rotation is produced. In other words, the rotations of output rings 214a, 214b may fully offset each other, such that, in some instances at least, ring housing 216 does not rotate.

Alternatively, output rings 214a, 214b may produce results that are additive in nature. For example, output rings 214a, 214b may have rotations that produce equal effects on pinions 218 and cause pinions 218 to rotate, and also cause pinions 218 to rotate ring housing 216. Of course, there may be non-equal rotations of output rings 214a, 214b which may combine in any number of different ways.

Further, as noted above, the rotation of output rings 214a, 214b may be of an oscillating nature, such that the rotation changes over time. For instance, the rotation may be generally sinusoidal. In the case of sinusoidal-like waveforms for the rotations of output rings 214a, 214b, it will be appreciated that the output to ring housing 216 can thus be influenced by the amplitude and phase of each output. For example, sinusoidal waveforms of equal amplitude that are one-hundred eighty degrees out of phase, when added together, cancel out. Thus, outputs of output rings 214a, 214b that are of equal magnitude and one-hundred eighty degrees out of phase may also cancel out, thereby generating no rotation of ring housing 216.

In contrast, combining sinusoidal waves of equal magnitude that are also directly in phase can produce a waveform that remains in phase, and thus has the same frequency, but has twice the amplitude. In this situation for output rings 214a, 214b, a significant rotation may be generated on ring housing 216. Naturally, by varying the degree to which the outputs of output rings 214a, 214b are in and out of phase, other additive effects between zero and the output of doubling the amplitude can be provided.

When the relative motions of output rings 214a, 214b produces a rotation on ring housing 216, there may also be a corresponding impact on the output at 204. In particular, as noted previously, input shaft 202 transfers its input to output shaft 204 through two idlers 220, 224 that are placed inside ring housing 216. As also noted previously, idlers 220, 224 may not be centered within ring housing 216. The effect of such an arrangement is that as housing 216 rotates, idlers 220, 224 can also be made to orbit around sun gears 203, 205. By introducing an orbital motion in the interactions between idlers 220, 224 and sun gears 203, 205, the rotation of sun gear 205 can be changed. In particular, the orbital motion of sun gears 203, 205 may add a relative velocity that may also be additive or subtractive relative to the input received at sun gear 203. In such conditions, the pass through of power can be modified by phase shifting assembly 200. Moreover, as eccentric gears 212a, 212b can introduce oscillating movements, phase shifting assembly 200 can modify the output to output sun gear 205 over time.

Accordingly, in phase shifting assembly 200, there are multiple differential systems that may be at work to generate an output that is based on relative motions of two inputs. For instance, an outer differential uses the two inputs of output rings 214a, 214b to generate an output that rotates housing 216. The rotation of housing 216 may, in turn, operate as an input to an inner differential. For instance, in the illustrated embodiment, the rotation of housing 216 can be a first input that causes idlers 220, 224 to orbit, while a second input is provided by input shaft 202 to sun gear 203. The relative magnitude and directions of rotations of sun gear 203 and housing 216 may thus be combined in the inner differential to produce a single output at output shaft 204.

A significant, although optional, feature of phase shifting assembly 200 is the ability to selectively vary the amount to which the relative motions of output rings 214a, 214b can be combined at the outer differential to rotate ring housing 216. Varying the relative motions of output rings 214a, 214b can be performed in any suitable manner. For instance, as described previously, eccentric gears 212a, 212b may be mounted to respective eccentric drive gears 210a, 210b. There may be a fixed position of eccentric gears 214a, 214b relative to each other. For instance, in FIGS. 1A and 2A, eccentric gears 212a, 212b are illustrated as being one-hundred eighty degrees out of phase, although they may be positioned in other ways. To thus vary the degree to which the motions of output rings 214a, 214b are in phase, one or both of eccentric gears 212a, 212b could be rotated to vary their phase relative to each other.

It is not necessary that eccentric gears 212a, 212b be moved, however, to alter the phase and/or amplitude of the output that can ultimately be provided to the inner differential and combined with the input to modify the output sent through output shaft 204. For example, in the embodiment illustrated in FIG. 2A, the positions of eccentric gears 212a, 212b may be unmodified. Instead, in this example embodiment, followers 250a, 250b can be selectively repositioned to change the phase of the output provided through eccentric gears 212a, 212b. Moreover, followers 250a, 250b can be independently moved to provide any different relative motion necessary to produce a desired output.

To change the position of follower 250a, for example, carrier shaft 261a may have a carrier shaft control gear 263a mounted thereto, or may have gear teeth formed thereon. When selectively engaged, a power source may cause carrier shaft control gear 263a to rotate, which in turn causes carrier shaft 261a to rotate. FIG. 2C illustrates a reverse perspective view of a follower 250 that generally reflects the operation of followers 250a, 250b in FIG. 2A, and can be used to illustrate the effect of rotating a carrier shaft 261. In particular, carrier shaft 261 is, in FIG. 2C, connected to a hybrid carrier arm 260. The relationship between hybrid carrier arm 260 and carrier shaft 261 may be fixed such that as carrier shaft 261 rotates, hybrid carrier arm 260 also rotates.

As shown in FIG. 2C, eccentric gear 212 may have gear teeth that engage following gear 262. Following gear 262 can mesh with transfer gear 264, which may be supported by hybrid carrier arm 260. Thus, as hybrid carrier arm 260 rotates, following gear 262 also rotates relative to eccentric gear 212. To maintain a constant mesh between transfer gear 264 and following gear 262, following gear 262 also rotates. Following gear 262 is, in this example embodiment, supported within a cam lever arm 258, and cam lever arm 258 also may be pivotally connected to hybrid carrier arm 260. In this manner, as hybrid carrier arm 260 rotates, cam lever arm 258 and following gear 262 may also experience a corresponding rotation about the center of carrier shaft 261.

The rotation of hybrid carrier arm 260 may follow a generally circular path. Due to the eccentric profile of eccentric gear 212 in the illustrated embodiment, movement of hybrid carrier arm 260 may not itself maintain following gear 262 at a constant distance from eccentric gear 212 so that proper engagement is maintained. Absent additional measures, movement of hybrid carrier arm 260 could work to move following gear 262 closer or further from eccentric gear 212. To substantially prevent this from happening, and to keep following gear 262 properly meshed with eccentric gear 262, cam lever arm 258 can also have a cam follower 256 attached thereto. On cam follower 256 there may be one or more follower studs 254. Eccentric gear 212 may have a cam surface 252 configured to mate with follower studs 254.

As cam lever arm 258 is rotated by hybrid carrier arm 260, cam lever arm 258 may pivot within hybrid carrier arm 260. Cam follower 256 and follower studs 254 may remain on cam surface 252 of eccentric gear 252 and thereby keep following gear 262 meshed with eccentric gear. In other words, as hybrid carrier arm 260 rotates, cam lever arm 258 may pivot and also cause following gear 262 to rotate around eccentric gear 212. However, cam follower 256 can keep following gear 262 engaged with eccentric gear 212. It should also be appreciated that cam follower 256 may also follow cam surface 252 even when follower 250 is not being moved. For example, as eccentric gear 212 rotates, cam follower 256 also moves with cam surface 252 to keep following gear 262 engaged with eccentric gear 212.

Accordingly, by rotating hybrid carrier arm 260, follower 250 can be rotated relative to eccentric gear 250. Such may be performed for multiple followers as well, thereby allowing the phase of output provided through use of eccentric gears 212 to be modified. In the embodiment of FIG. 2A, and as described previously, modification of the phase also allows amplitude of an output to possibly be modified and combined with the input to phase shifting assembly 200, thereby producing a reciprocating output that has a magnitude greater or less than the input.

In using the phase shifting assembly to modify the output, such output may then be provided to an output system as described elsewhere herein. In some embodiments, the modified output is provided for a specified duration. For instance, a transmission (e.g., transmission 100 of FIG. 1A) may have multiple output drive gears that can engage with an output driven gear. In shifting from one drive gear to another drive gear, and thereby changing the ratio through the transmission, it may be desirable to maintain a constant engagement between the power source and the load. While the two different gears may have different ratios, they may also be rotating on different shafts. By bringing the speed of the engaged drive gear up and reconciling it with the speed of the second shaft that drives a to-be-engaged gear, it may be possible to connect both the engaged and to-be-engaged drive gears simultaneously to the driven gear. By then disconnecting the engaged gear, the to-be-engaged gear can become the new engaged gear, and the power source and load can remain connected through a gear ratio change. In operation, use of a phase shifting assembly to reconcile the speed of the engaged gear with the speed of the to-be-engaged gear changes the gear ratio from the ratio of the engaged gear to the ratio of the engaged gear. Further, such changes occur by gradually increasing the speed, thereby sliding between gear ratios, such that ratio changes are effected in very small, if not infinitely small, increments. A similar change can be effected by altering a speed of a to-be-engaged gear to reconcile that speed with the speed of an engaged gear. In the description and foregoing claims, a “driven” gear is also referred to as a “driveable” gear. In particular, a driven or driveable gear includes a gear which can receive power from a drive gear, and refers to the system while operating under load or when not under load. For example, a gear in a transmission may be considered to be a “driven” or “driveable” gear regardless of whether or not the transmission is operating at the time.

As noted above, when phase shifting assembly 200 is activated, the phase of eccentric gears 212a, 212b and/or followers 250a, 250b relative to each other can produce a change to output 204. Moreover, such output can have a reciprocating waveform. In the examples above in which speeds of engaged and to-be-engaged gears are reconciled using the phase shifter, there may be only a small window of time during which the speeds are reconciled. Accordingly, it may be desirable that the drive gears be engaged with the driven gear at the same time only during that window. As a result, the to-be-engaged gear may need to engage during that window and the previously engaged gear may need to disengage during that window.

As will be appreciated in view of the disclosure herein, eccentric gears 212a, 212b may rotate at high speeds in some applications, which can then create a very small window of time at which speeds are reconciled. There are various manners in which that window can be lengthened, however. For example, FIGS. 1A and 1B illustrate a transmission 100 in which a splitting gear 112 delivers torque along multiple torque paths, and two such torque paths begin as splitting gear 112 engages output gears 114a, 114b. In FIG. 1A, output gears 114a, 114b are larger in size than splitting gear 112. As a result, output gears 114a, 114b can rotate at a reduced speed relative to transmission input 110. This reduced speed can also be passed to phase shifting assemblies 200a, 200b. As the rotational speeds within phase shifting assemblies 200a, 200b have been reduced, the time of the reconciling window may have increased.

The example embodiment in FIGS. 1A and 1B, eccentric gears 212a, 212b are shown as being external to output system 300. While eccentric gears 212a, 212b and phase shifting assemblies 200a, 200b could also be within output system 300, advantages for some applications can be obtained. For example, it may be easier to modify eccentric gears 212a, 212b while eccentric gears 212a, 212b are external to output system 300. The size of eccentric gears 212a, 212b could be greatly increased and/or the manner in which eccentric gears 212a, 212b are driven modified, so that the rotational speed of eccentric gears 212a, 212b is slowed down considerably, thereby also increasing the window for reconciling drive gears of different ratios.

Still another manner for increasing the window is discussed hereafter relative to the hybrid tooth profile of the hybrid accelerator. According to one such embodiment, teeth on the hybrid accelerator may change in size and/or profile around the eccentric gear. For example, as the base circle radius changes from one gear tooth to the next, at least the tooth profile may change to reflect the changed base circle radius. The changes in tooth profile can result in an acceleration as the eccentric gear rotates. Moreover, acceleration may also be obtained even with the multiple teeth of different of different profiles and/or sizes having the same diametral pitch. Not all teeth need be different sizes and/or profiles, however. In another example, multiple teeth of the same size and/or profile may be positioned next to each other. With multiple teeth of the same profile next to each other, a constant speed can be obtained for a period of time and used as a window during which drive gear speeds are reconciled. Further, by increasing the window and/or slowing down the time over which a gear ratio change is made, a torque spike may also become more manageable. For example, the window may be the time to rotate over a single tooth, over two teeth, or more teeth (e.g., 20 teeth), although the specific number of teeth that may provide the window is configurable and may be more or less than twenty, which is merely an example.

Additionally, as noted previously, phase shifting assemblies 200 may be selectively engaged. Such selective engagement may occur in at least two manners. For example, according to one embodiment, phase shifting assemblies 200 are operated such that eccentric gears 212a, 212b rotate, but they rotate exactly out-of-phase so that their relative velocities cancel out. With the relative velocities cancelling out, there may not be any modification to the output.

In another embodiment, however, eccentric gears 212a, 212b may not always rotate. For example, eccentric gears 212a, 212b may be driven by drive gears 210a, 210b. Drive gears 210a, 210b may be selectively actuated only when desired, such as during a gear ratio change. Any power source may be used to actuate drive gears 210a, 210b. For instance, drive gears 210a, 210b may be driven by a take-off of the input power, or they may be operated by an independent power source or actuator.

Described herein are therefore various particular examples of components and assemblies for maintaining constant engagement during changes between gear ratios, as well as for combining reciprocating inputs. Accordingly, each of phase shifting assemblies 200, 200a, 200b are thus examples of physical implementations of means for maintaining constant engagement while changing between gear ratios, as well as means for combining reciprocating inputs. Indeed, the maintenance of constant engagement may be through positive displacement and synchronization of speeds and/or gear teeth, such that phase shifting assemblies 200, 200a, 200b are also examples of physical implementations of means for synchronizing gears for constant engagement=during a gear ratio change. Further, as a reciprocating input may be produced within a phase shifting assembly, phase shifting assemblies 200, 200a, and 200b are also examples of means for producing a reciprocating input.

It should also be appreciated that the description of the phase shifting assemblies provided herein is merely exemplary, and that a variety of other phase shifting assemblies and/or eccentric gears may be used. For instance, while two phase shifting assemblies 200a, 200b are illustrated in FIGS. 1A, 1B this is only exemplary. In some embodiments, there may only be a single phase shifter. The singe phase shifter may, for instance, selectively operate with each of two drive shafts, and can alternate between drive shafts as a gear ratio change is made. Additionally, it is not necessary that the phase shifter carry the load, and a phase shifter may instead operate outside the torque path and then engage and disengage without carrying the load.

Furthermore, while the illustrated embodiment shows a pass-through option on the phase shifter, such a feature is also merely exemplary. In other embodiments, a pass-through is eliminated. For example, a phase shifter can operate on its own such that if there is any movement to ring housing 216, for example, that is the power that is conveyed. As a result, the phase shifter may have zero output or some net output based on the phase of eccentric gears within the phase shifter. In still other embodiments, followers 250a, 250b may be used to drive phase shifter. For example, by rotating followers 250a, 250b around eccentric gears 212a, 212b, followers 250a, 250b may themselves generate a rotation in eccentric gears 212a, 212b used in changing between gear ratios.

### 3. Hybrid Tooth Profile of Hybrid Accelerator

FIG. 2D illustrates a side view of hybrid accelerator 212 from FIG. 2C. As shown most clearly in FIG. 2D, hybrid accelerator 212 may be an eccentric gear. Specifically, it can be seen that hybrid accelerator 212 may have a center of rotation that is off-center relative to eccentric gear 212. In the illustrated embodiment, a center of rotation for hybrid accelerator 212 may be, for example centered within an opening 213 formed in a body of hybrid accelerator 212, although it is not necessary that an opening be formed in hybrid accelerator 212 in all embodiments. Regardless of the specific embodiment, when hybrid accelerator 212 rotates about an off-center axis or center of rotation, a reciprocating motion may be produced.

For instance, as hybrid accelerator 212 is caused to rotate by a shaft within opening 213 or by another means (e.g., by being attached to an eccentric drive gear 210a, 210b), the non-central center of rotation generates oscillation within hybrid accelerator 212. In connection with hybrid accelerator 212, the oscillation may have a generally sinusoidal waveform. It will be appreciated, however, that an eccentric gear need not have a sinusoidal motion. For example, while hybrid accelerator 212 has a generally circular appearance overall, it could be created in any number of other symmetric, or non-symmetric shapes that could produce other waveforms. Additionally, it should be appreciated that the oscillating motion of a hybrid accelerator may be produced over a full or partial rotation of hybrid accelerator 212. In one embodiment, for instance, hybrid accelerator 212 produces a full waveform over a single rotation. In other embodiments, a single rotation of a hybrid accelerator may produce multiple waveforms. In still other embodiments, however, motion may be reciprocating even though power output on the waveform is utilized over only a partial waveform.

The eccentric design of hybrid accelerator 212, as well as the sinusoidal and/or reciprocating motion of hybrid accelerator 212, can have useful consequences. For example, a gear with standard involute teeth, as is known in the art, may have a gear body with multiple teeth formed around a perimeter thereof, and such teeth may follow the standard equations and principles of involutometry. The use of a standard involute curve in the shape of gear teeth has various unique advantages, including the production of conjugate action. Specifically, mating gear teeth act against each other to produce rotary motion in a manner similar to cams. Indeed, mating involute gears operate essentially in the same manner as a pair of cams, but they operate through a relatively small arcuate path and are then replaced by another identical set of teeth/cams before moving off the involute curve. This conjugate action of gear teeth can be used to generate a constant angular-velocity ratio during meshing. Involute teeth have specific characteristics as it relates to contact behavior, kinematics, stress, and wear. As a gear tooth shape deviates from an involute curve, the benefits of involutometry are a diminished.

To generate a standard involute curve, the radius of a base circle is used. On a standard gear designed to rotate about its center, the base circle is the same for each tooth, and each tooth therefore has the same involute profile. As the involute curve is a function of the base circle, gears with different base circle radii will have different involute curves. Consider, for example, two gears with involute gear teeth, and which are configured to mesh. If the meshing gears have different sized base circles, the involute profiles of the gear teeth will be different from one gear to the other. The different sized profiles on gears of different sizes has been considered fundamental to satisfying involutometry fundamentals in such gears.

Returning now to FIG. 2D, it can be appreciated that due to the eccentricity of hybrid accelerator 212, the radius of the base circle changes around hybrid accelerator 212. This is illustrated by the differences between distances A and B on hybrid accelerator 212. For example, the distance A from the center of rotation of hybrid accelerator 212 to the base circle of hybrid accelerator 212 is less than the distance B from the center of rotation of hybrid accelerator 212 to a different point on hybrid accelerator 212. Indeed, by moving radially around hybrid accelerator 212, the base circle radius can increase or decrease, and such change may occur in infinitely small increments. As can be appreciated, inasmuch as the base circle radius changes around hybrid accelerator 212, standard involutometry equations would produce different involute curves, and thus different gear teeth profiles, around the circumference of hybrid accelerator 212.

Moreover, the base circle radius can change not only from tooth-to-tooth on hybrid accelerator 212, but from a starting point of a tooth to an endpoint of a tooth. This circumstance therefore makes calculation of an involute curve significantly more demanding. To that end, a set of equations have been used and developed by the inventors hereof to facilitate generation of a gear tooth profile that takes into account the ever changing base circle radius. It will be noted that in the equations for describing the involute curve for a gear tooth having a changing base circle radius, a single gear tooth may not have only a single radius to the involute curve (rᵢₙᵥ), but may instead have an array of rᵢₙᵥ. An array of pressure angles (φ) may also used.

The various equations used and derived can be found in the Appendix section herein, which also includes a list of various variables used in the equations, as well as a .m program usable to calculate and plot the shape of a gear tooth profile for a gear with a changing base circle radius. Such equations, and modifications thereof that would be apparent to the person of ordinary skill in the art, are considered to fall within the scope of the invention.

A detailed discussion of the use and derivations of each of the equations in the Appendix section can be found in U.S. Application Ser. No. 61/195,457, filed on Oct. 6, 2008, and entitled “CONCEPTUAL DESIGN AND ANALYSIS OF A POSITIVELY ENGAGED CONTINUOUSLY VARIABLE TRANSMISSION,” which also provides a general overview of the manner in which the equations can be used to define a gear tooth profile that, while not satisfying standard equations of involutometry, nevertheless continues to satisfy principles of involutometry. In understanding the equations, the nomenclature is important. Some equations and variables, for example, describe an “initial” profile, while other equations describe a “hybrid” profile and/or a “final” profile.

Using such nomenclature for a single tooth, an initial profile may generally be considered to include an involute profile and properties at a starting point of a tooth, and as generated using the base circle radius at such starting point. Similarly, a final profile may generally be considered to include an involute profile and properties at an ending point of a tooth, and as generated using the base circle radius at such ending point. Accordingly, “initial” and “final” profiles can, in some embodiments, be calculated using standard involutometry equations.

A hybrid profile, in contrast, includes an involute profile and properties that, in some embodiments, cannot be fully described only by standard involutometry equations. A hybrid profile may, however, take into account the changing base circle radius along width of the tooth. Moreover, according to the equations derived, a hybrid profile can, in some embodiments, maintain involute laws and behavior, but have a velocity along a line of action may not be constant. This can be because hybrid involute profile will function as an involute during a transition between gear ratios, with the gear ratio changing due to the changing base circle radius.

In describing and plotting the hybrid involute profile, equations 88-93 in the Appendix are particularly noteworthy. For example equations 92 and 93 use other values established in equations 88-91 to provide a Cartesian plot of an involute curve. It will be seen that equations 88-93 are similar to equations 82-87 and 94-99 for initial and final tooth profiles, respectively. As noted previously, however, due to the changing base circle radius considered during a hybrid tooth profile calculation, values considered during the hybrid involute profile calculations may be less straightforward, and may use arrays of values for a variable, rather than single value for such a variable. Further, while the Cartesian Y-value for a standard involute equation may be based on a corresponding X-value and value for the radius to the involute curve, the Y-value for a hybrid involute gear also considers pitch radii at the final and original positions.

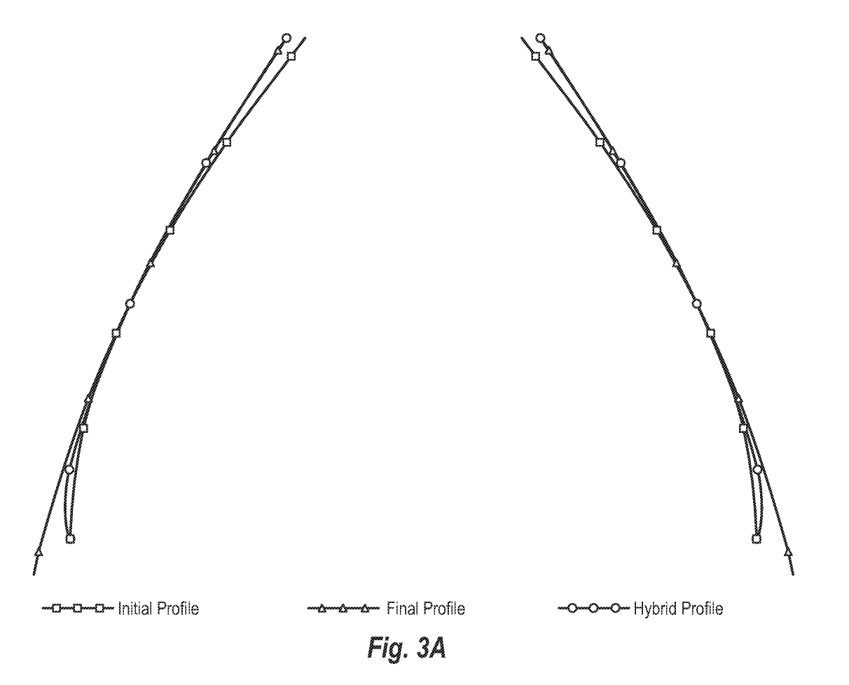

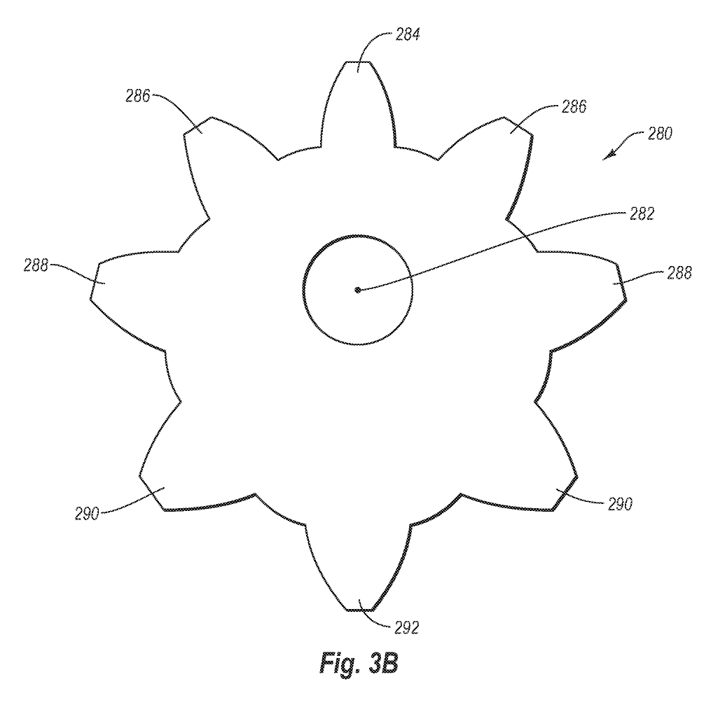

FIG. 3A is an example illustration of the differences between a standard involute curves and some example hybrid involute curves, as generated by the equations in the Appendix. In particular, FIG. 3 illustrates involute and hybrid involute curves corresponding to a single tooth using initial, final, and hybrid analysis. As shown in FIG. 3A, the hybrid profile is itself different than either the initial or final profile; however, the initial and final hybrid profiles serve as boundary conditions for the hybrid profile. For instance, the hybrid profile can behave as the initial profile at the first point of contact, and behave as the final profile contact. Thus, the start position of the hybrid profile can correspond to the start point of the initial profile. The end position of the hybrid profile may then correspond to the final profile. Between the start and end positions, a hybrid profile curve can behave like an infinite number of intermediate involute profiles so as to maintain involute properties.

In a broader sense, a hybrid tooth may be considered to have an involute shape properties of both its initial and final profiles. For instance, the height of the tooth may correspond to the tooth height of the initial profile inasmuch as the initial profile and the hybrid profile may share the same start point. Additionally, while FIG. 3A is merely an illustration, it can be seen that a hybrid profile, according to some embodiments, may generally start at the initial position and be between the initial and final profiles until a boundary condition in which the initial and final profiles are equal, at which position the hybrid profile is also equal. After that point, the hybrid profile may closely mirror the final profile and be equal to the final profile at the end position.

As suggested by the example in FIG. 3A, the calculation of a hybrid profile does not necessarily result in the tooth being symmetric. This is particularly so W<inasmuch as the base circle radius may increase or decrease over the full width of a tooth. Thus, the leading and trailing involute curves may have different profiles.

Equations 89-93 in the Appendix may also considered to be more robust forms of equations 76-87 and 94-99. As should be appreciated by one skilled in the art in view of the disclosure herein, where a gear has a constant base circle radius, the initial and final profile should be equal. Moreover, in such a case, equations 89-93 can also be used to develop an involute curve that is essentially identical to an involute curve produced by standard involutometry equations.

To illustrate some aspects of an example of the application of the hybrid profile with multiple teeth on a gear, FIG. 3B is provided. In FIG. 3B, an eccentric gear 280 is shown, and is configured to rotate about a rotational center 282. Rotational center 282 may not correspond to the center of mass and/or eccentric gear 280 may otherwise be configured to have a changing base circle radius. It should be appreciated that gear 280 is illustrated to visually identify aspects of an example embodiment of an eccentric gear. Accordingly, the geometry of eccentric gear 280 has been exaggerated to illustrate various aspects of a hybrid gear. Eccentric gear 280 is not, therefore, necessarily drawn to scale or proportion in all aspects. No inference should thus be drawn that eccentric gear 280 is limiting of the present invention.

As illustrated in FIG. 3B, rotational axis 282 of eccentric gear 280 may be positioned such that a base circle radius at one or more teeth (e.g., tooth 284) is less than a base radius at one or more other teeth (e.g., tooth 292). For instance, while the illustrated example is presented by way of illustration and not limitation, the base circle radius according to one embodiment may increase around approximately one-hundred eighty degrees of eccentric gear 280, and decrease around a second one-hundred eighty degrees of eccentric gear 280. This may, for example, allow eccentric gear 280 to be symmetric around a single axis, although it is not necessary that eccentric gear 280 be symmetric around any axis.

Inasmuch as the base circle radius can change as one moves radially around eccentric gear 280, different gear teeth profiles may be generated, and the tooth profiles may vary from one tooth to the next based on a radial position of the tooth relative to rotational center 282, as well as based on a variety of factors. Such other factors may include, for example, the number of teeth on the gear, the size of the gear, the shape of the gear, and the pressure angle, although alternative or additional factors may also be considered.

Using the description of a hybrid profile as previously disclosed herein, the profile of each tooth of gear 280 can be developed. In the illustrated embodiment, five different hybrid profiles have been generated on gear 280, with such teeth generally increasing in size from tooth 284 to tooth 292. In particular, tooth 284 and tooth 292 may have different hybrid profiles and can be angularly offset from each other around the circumference of gear 280 at approximately a one-hundred eighty degree offset. In this embodiment, tooth 284 is positioned approximately at a location with a minimum base circle radius, and tooth 292 is at a position approximately at a location with a maximum base circle radius. Further, between teeth 284 and 292 are additional teeth 286, 288, 290 which each have different hybrid tooth profiles. In this embodiment, each half of eccentric gear 280 has an identical set of teeth, thereby providing a single axis of symmetry along a line splitting teeth 284 and 292 in half.

While eccentric gear 280 thus illustrates that each half of eccentric gear 280 has a set of teeth, each of which are different, it should be appreciated that this is not necessary for all embodiments of the present invention. Indeed, in one embodiment, it is contemplated that an eccentric gear have a series of consecutive teeth that each have a constant base circle radius. This may allow an engaging gear to, for a period of time, have a constant-angular velocity ratio in addition to satisfying other involutometry principles.

A series of identical teeth may be used, for example, in a transmission such as transmission 100 illustrated in FIGS. 1A and 1B. As discussed herein, hybrid accelerators 212a, 212b, for example, can be eccentric gears and can be used to produce a change in gear ratios. For example, multiple gear ratios can be defined between a gear that meshes with hybrid accelerators 212a, 212b merely by virtue of the gear teeth of hybrid accelerators 212a, 212b that may have tooth profiles based on different base circle radii. In some example embodiments also described herein, hybrid accelerator 212a, 212b may not be the sole mechanism for effecting a gear change. For instance, gear ratio changes may also be made by engaging different drive gears with one or more driven gears. In example embodiments disclosed herein, an engaged drive gear may remain engaged while a to-be-engaged gear comes into engagement with the driven gear. There may be some overlap in time during which both drive gears are engaged.

To allow both drive gears to be engaged at the same time, hybrid accelerators 212a, 212b may be activated, which can create an acceleration that reconciles different speeds of the engaged and to-be-engaged gears. If each gear tooth on hybrid accelerators 212a, 212b is different than a preceding and following tooth, there may be a very short window where the speed of engaged and to-be-engaged gears are completely reconciled. By placing multiple gear teeth of approximately the same profile next to each other, the time during which the speeds are reconciled may be extended, which can allow greater flexibility in engaging the to-be-engaged gear, and disengaging the engaged gear.

While example embodiments can therefore utilize a hybrid tooth profile on one or more gears in a power transfer system such as those described herein, it should be appreciated that this is exemplary only. For example, the disclosed hybrid profile may follow involute properties that create desirable durability and wear characteristics in a high-torque and/or high-speed application. Other applications may, however, allow for greater tolerances and, in such cases, an eccentric gear may not follow the previously disclosed hybrid profile. Indeed, in other embodiments, an eccentric gear with standard involute teeth could potentially be used.

In other embodiments, other types of hybrid gear teeth are used. For instance, rather than using the hybrid involute profile disclosed herein, gear teeth geometries may be determined by using an average base circle radius. In another embodiment, a hybrid gear tooth may combine initial and final tooth profiles by, for example, matching the initial profile at a starting position up to a point where the final and initial profiles match. At an intersection of the initial and final profiles, an alternative hybrid profile may then follow the final profile, rather than the initial profile, up to the ending point on the curve. Thus, a hybrid profile in some embodiments may be a curve that does not fully conform to either an initial or final profile but which has boundary conditions set by the initial and final profiles, matches portions of the initial and/or final profile, and/or shares characteristics of the initial and final profiles.

Thus, a variety of types of standard involute, hybrid involute, and hybrid gears may be used in connection with embodiments of the present invention, and each may be suitable for some applications. Further, an eccentric gear may, in some embodiments, have teeth that change shape around the profile thereof, while in other embodiments, all the teeth may be the same shape. In any such case, the application may determine the practicality of such example tooth profiles. For instance, in high tolerance applications, some tooth profiles may not mate precisely, thereby creating noise and wear concerns. The same tooth profiles may, however, be used in other lower tolerance applications without concern.

It can be appreciated in view of the disclosure herein that an eccentric gear and/or hybrid profile can thus be used in accordance with a number of different types of systems and components to produce a reciprocating input that may, in some examples, be an accelerating input. Accordingly, eccentric gears 212, 212a, 212b and 280 are examples of physical implementations of means for providing a reciprocating input as well as a means for accelerating an input. Additionally, the acceleration may be used in changing gear ratios, while maintaining involute contact. Thus, eccentric gears 212, 212a, 212b and 280, whether individually or in connection with other components or assemblies such as phase shifting assemblies 200, 200a, 200b, are also examples of physical implementations of means for changing a gear ratio, means for providing involute contact with non-standard involute gear teeth, and means for maintaining constant engagement while changing between gear ratios.

### 4. Interaction of Output Assembly and Phase Shifter Assembly

Returning briefly to FIGS. 1A and 1B, and as noted previously, power passed through phase shifters 200a, 200b may be transferred to output system 300, and more specifically to output drive shafts 310a and 310b. For example, in FIGS. 3A and 3B, output system 300 is illustrated along with the connection to phase shifter assemblies 200a, 200b (FIGS. 1A-2B) via phase shifter output shafts 204a, 204b. Specifically, as power is provided to phase shifter assemblies 200a, 200b in the form of a rotational input, phase shifter carrier gears 205a, 205b rotate, thereby also causing phase shifter carrier shafts 204a, 204b to rotate. Phase shifter carrier shafts 204a, 204b may, in turn, be connected to trap shafts 322a, 322b positioned within output drive shafts 310a, 310b.

The rotation of trap shafts 322a, 322b may also be linked to one or more drive gears 312a-317b on output drive shafts 310, 310b. For instance, as illustrated in FIGS. 4A and 4B, multiple drive gears 312a-317b are optionally nested together on output drive shafts 310a, 310b. In one embodiment, and as disclosed in greater detail hereafter, drive gears 312a-317b are floating gears that are positioned on drive shafts 310a, 310b, but are only selectively fixed to a respective trap shaft 322a, 322b. In particular, while trap shafts 322a, 322b may control the rotation of drive gears 312a-317b, trap shafts 322a, 322b may be selectively fixed to less than all of drive gears 312a-317b at a given time, and even less than all gears on a single drive shaft 322a, 322b. Trap shafts 322a, 322b may also be selectively fixed to drive shafts 310a, 310b as discussed in greater detail hereafter.

To illustrate the above, one embodiment includes a trap shaft 322a which may pass through the interior of output drive shaft 310a. Trap shaft 322a can be selectively fixed to one or none of drive gears 312a-317a at any particular time. For instance, trap shaft 322a may be selectively fixed to drive gear 312a, but drive gears 312b-312f may not be fixed and may be allowed to freely rotate around drive shaft 310a. When such a relationship is present, the rotation of trap shaft 322a can also cause a corresponding rotation of drive gear 312a. Drive gear 312a may, in turn, mate with a corresponding driven gear 352 on main output gear 350. As a result, drive gear 312a can then drive main output gear 350 at a gear ratio that corresponds to the ratio between drive gear 312a and driven gear 352. Main output gear 350 be formed as a single, unitary gear that includes each of driven gears 352-362 and, when rotated, can then provide an output to transmission output 120. Such output provided by output main gear 350 may be provided directly to a transmission output, or may optionally pass through other systems such as reverse differential system 400.

In the illustrated embodiment, as main output gear 350 rotates, the various a driven gears 352-362 may collectively rotate and may remain engaged with each of the drive gears 312a-317b. Inasmuch as drive gears 312a-317b optionally float when not fixed to trap shafts 322a, 322b, output main gear 350 may thus, as it rotates, rotate other of drive gears 312a-317b that are not at that time fixed to trap shafts 322a, 322b. As a result, while each of drive gears 312a-317b may remain in mesh with main output gear 350, not all of drive gears 312a-317b are actively transferring power from the power source to the load.

Further, an “engaged” gear may be one which is fixed to trap shaft 322a, 322b, for example, and thus can transfer power from a drive gear to main output gear 350. An “unengaged” or “non-engaged” gear may thus be a gear that is not fixed (e.g., to trap shafts 322a, 322b) and thus does not convey power from a drive gear to main output gear 350. A “to-be-engaged” gear may be an unengaged gear which is about to become an engaged gear (e.g., to change a gear ratio within a transmission). It may thus be appreciated by one skilled in the art in view of the disclosure herein, that while gears may remain in mesh, they nonetheless may be unengaged or non-engaged as they do not transmit power from the power source to main output gear 350. Indeed, as such unengaged gears can remain in mesh with main output gear 350, when an engaged gear does rotate main output gear 350, main output gear 350 may rotate unengaged of drive gears 312a-317b about their respective drive shafts 310a, 3100b. As unengaged of drive gears 312a-317 may thus be unfixed relative to trap shafts 322a, 322b, rotation of unengaged gears 312a-317b may also have no corresponding defect on drive shafts 310a, 310b.

The above description relative to drive gear 312a is merely illustrative and any of drive gears 312a-312f may be selectively fixed so as to convey power from a trap shaft 322a, 322b to output main gear 350. Further, in some embodiments, output system 300 can operate in a sequential fashion such that a particular sequence is followed as output system 300 is used to go from a low gear to a high gear, or vice versa. For instance, drive gear 312a may provide a first, low gear when engaged with driven gear 352 on output main gear 350. As each of drive gears 312a-317b may float on a respective drive shaft 310a, 310b, selective engagement of the drive gears 312a-317b can be sequential, and selective, so that progression through each of drive gears 312a-317b can be implemented. It is not, however, necessary for all embodiments that drive gears 312a-317b be used sequentially when moving through gear ratios. In some embodiments, for example, it may be possible to skip gears or to vary the progression through drive gears 312a-317. Indeed, by using the phase shifter assemblies 200a, 200b described herein, it may even be possible to maintain constant engagement and connection between the power source and the load while skipping over particular drive gears.

In sequential operation, as higher gear ratios are desired or needed, output system 300 may sequentially fix different drive gears 312a-317b to their respective trap shafts 322a, 322b to provide power to output main gear 350. By way of example, in the gear progression and as a higher gear ratio is needed, drive gear 312a can be unfixed from trap shaft 322a so as to stop transmitting power to driven gear 352. The next, higher, gear ratio may be provided by drive gear 312b which can then be fixed to trap shaft 322b so as to transmit power from drive gear 312b to output main gear 350 through driven gear 352. If a still higher gear ratio is needed, drive gear 312b can be released from trap shaft 322b, and drive gear 313a may be fixed to trap shaft 322a, thereby again transmitting power from trap shaft 322a to output main gear 350, but this time through drive gear 313a and driven gear 354. Such a progression may continue, by alternating between the twelve drive gears 312a-317b on drive shafts 310a, 310b until a highest gear ratio is obtained by, for example, releasing drive gear 317a from trap shaft 322a and fixing drive gear 317b to trap shaft 322b so that drive gear 317b drives power through driven gear 362 on output main gear 350.

Notably, the above illustration is merely one example and, in other embodiments, drive gears 312a-317b may be progressed through in other manners. Moreover, in the progression, one or more of drive gears 312a-317 may provide a reverse gear and one or more of drive gears 312a-317b may be used in providing an engaged neutral. Furthermore, the above illustration should not be interpreted as requiring that one drive gear be unfixed from a respective trap shaft 322a, 322b before a next drive gear can be fixed and used to transmit power. Indeed, depending on the transmission in which output system 300 is used, fixing of one drive gear may occur at the same time another drive gear is unfixed, or can occur before or after such other drive gear is unfixed.

For example, and as will be appreciated by one skilled in the art in view of the disclosure herein, the relationship between drive gears 312a-317b and driven gears 352-362 provide various fixed, discrete gear ratios at which a transmission may operate. However, while drive gears 312a-317b of output shafts 310a, 310b can thus define individual, discrete gear ratios relative to driven gears 352-362, the overall gear ratio of a transmission (i.e., the ratio of transmission input 110 to transmission output 120 of transmission 100 in FIG. 1A) may be dependent on a number of other factors. For example, phase shifter assemblies 200a, 200b and reverse differential assembly 400, as described herein, can each affect the overall gear ratio of transmission 100. Additionally, other elements, including linking gears, differentials, and other gear sets may also provide gear ratio changes through transmission 100.

As an illustration, multiple phase shifter assemblies 200a, 200b (FIGS. 1A-2B), as described previously, can be used and connected to trap shafts 322a, 322b. Each of the phase shifter assemblies 200a, 200b may operate independently, and can thus transform the input from the transmission in different manners and/or to different extents. According to one embodiment, drive gear 312a, for example, may be fixed to trap shaft 322a and used in conveying power to driven gear 352. As described above, an input may pass through a corresponding phase shifter assembly (e.g., phase shifter assembly 200a) without a phase shifting output. Alternatively, phase shifter assembly 200 may be activated, such as when a gear ratio change is desired.

By using the phase shifter to vary the frequency and/or amplitude of the input, as described above for instance, the output to carrier shaft 204a can be changed. As the output of carrier shaft 204a is changed, the rotational speed of trap shaft 322a and drive gear 312a also change, thereby changing the overall gear ratio of transmission 100 (FIG. 1A), even with drive gear 312a and driven gear 352 having a fixed ratio therebetween.

Moreover, if it becomes desirable to change ratios by engaging a different drive gear 312a-317b and/or driven gear 352-362, the change can be made so that multiple drive gears 312a-317b are connected to one or more driven gears 352-362 at the same time. Thus, there is no period where the transmission disconnects the power source from the load.

Assume, for instance, a transmission, such as transmission 100 for example, receives an input with a rotational speed of 2000 rpm. Initially, such input may be passed directly through phase shifters 200a, 200b to cause trap shafts 322a, 322b to also rotate at 2000 rpm, although some gear ratio may also be provided even on a pass-through of phase shifters 200a, 200b. If drive gear 312a is fixed to trap shaft 322a and has a 5:1 gear ratio relative to driven gear 352, output main gear 350 would have a rotational speed of 400 rpm. Drive gear 312b, however, may have a 4:1 gear ratio relative to driven gear 352. Accordingly, if drive gear 312b were fixed to trap shaft 322b and had a direct pass-through of the 2000 rpm input, drive gear 312b would provide output main gear 350 with a rotational speed of 500 rpm. Under such example conditions, it would be difficult, if not impossible, to fix both drive gear 312a and drive gear 312b inasmuch as they would cause driven gear 352 to operate at different speeds.

However, if the speed of drive gear 312a can be modified to produce a corresponding change in the rotational speed of driven gear 352 that equals the speed at which drive gear 312b drives driven gear 352, both drive gear 312a and drive gear 312b may be simultaneously connected to driven gear 352. For instance, by activating phase shifting assembly 200a and producing an additive effect that modifies the amplitude of the 2000 rpm input by approximately twenty-five percent, such that the rotational speed of trap shaft 322a is 2500 rpm, the 5:1 gear ratio of drive gear 312a to driven gear 352 would drive driven gear 352 at 500 rpm. In such a case, both drive gears 312a and 312b could be fixed on respective trap shafts 322a, 322b at the same time inasmuch as they provide the same output speed to driven gear 352. Sometime after mutual engagement, drive gear 312a could be unfixed from trap shaft 322a, and drive gear 312a could float on drive shaft 310a.

It should be appreciated in view of the disclosure herein, however, that it is not necessary to bring drive gear 312a up to speed. Indeed, in other embodiments, drive gear 312b may be brought down to speed. For instance, by activating phase shifter 200b and producing a subtractive effect that modifies the amplitude of the 2000 rpm input by approximately twenty percent, such that the rotational speed of trap shaft 322b is 1600 rpm, the 4:1 gear ratio of drive gear 312b to driven gear 352 would drive driven gear 352 at 400 rpm. In such a case, both drive gears 312a and 312b could be connected at the same time inasmuch as they provide the same output speed. Sometime after mutual engagement, drive gear 312a could be unfixed from trap shaft 322a, and drive gear 312a could float on drive shaft 310a.

In both of the foregoing examples, only one of phase shifters 200a, 200b is activated at any given time to either bring drive gear 312a up to speed or to bring drive gear 312b down to speed. Thus, in some embodiments, only a single phase shifter may provided, and it may alternately increase or decrease speeds of engaged and to-be-engaged drive gears. In other embodiments, however, multiple phase shifters 200a, 200b can both be activated at the same time. For example, drive gear 312a could have its speed increased, whereas drive gear 312b could have its speed decreased.

The foregoing examples, including the provided operating speeds, gear ratios, drive and driven gears that are used to convey power, and progression of drive gears, are merely examples to facilitate understanding of aspects of example embodiments of the present invention. It will be appreciated in view of the disclosure herein that, for example, output system 300 may operate at a number of different speeds. Additionally, drive gears 312a-317b and driven gears 352-362 may have any of a variety of different gear ratios, and amplitude changes such as those provided by phase shifters 200a, 200b can be used to simultaneously fix any of a variety of different drive gears 212a-217b. Furthermore, while the foregoing illustration describes phase shifters 200a, 200b as having pass-through rotations that are equal, this need not be the case and in some embodiments phase shifters 200a, 200b may have differing output rotational velocities.

Accordingly, while the gear ratios defined by the various drive gears 312a-317b and driven gears 352-362 may be fixed and discrete, the transmission gear ratio may not be fixed while the power source is coupled to the load. While merely one example, and as noted previously, phase shifter assemblies 200a, 200b (FIGS. 1A-2B) can allow for frequency and/or amplitude modulation within transmission 100. When the amplitude, for example, is modulated, the speed of one or more drive gears 312a-317b may be altered, thereby changing the effective gear ratio between transmission input 110 and the output of actuated driven gear 352. In other words, phase shifter assemblies 200a, 200b can vary system-wide gear ratios, despite the fixed relationship of drive gears 312a-317a and driven gears 352-362. Such changes in gear ratio can also be made in very small, and possibly infinitely small, increments by, for example, altering amplitude within a phase shifter assembly 200a, 200b.

The interactions between output assembly 300 and phase shifting assemblies 200a, 200b can thus provide a variety of useful features. For instance, output assembly 300 may have various gear ratios, and can even engage multiple gears at the same time despite differences in gear ratios, as discussed herein. Phase shifting assemblies 200a, 200b may facilitate the same. For example, by reconciling and synchronizing the inputs of multiple gears, the multiple gears can be engaged at the same time. Thus, output assembly 300 and phase shifting assemblies 200a, 200b are both examples of physical implementations of means for varying gear ratio and for maintaining constant engagement while changing between gear ratios. Output assembly 300 and phase shifting assemblies 200a, 200b are thus further examples of physical implementations of means for simultaneously engaging two or more drive gears, which means may also simultaneously engage two more drive gears of different fixed gear ratios to the same output.

### 5. Ball Gear Selector

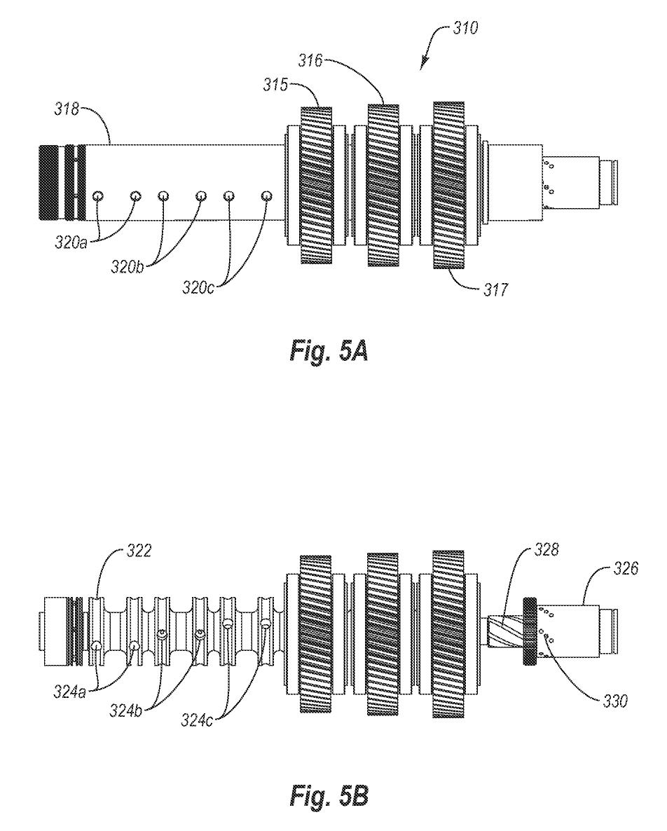

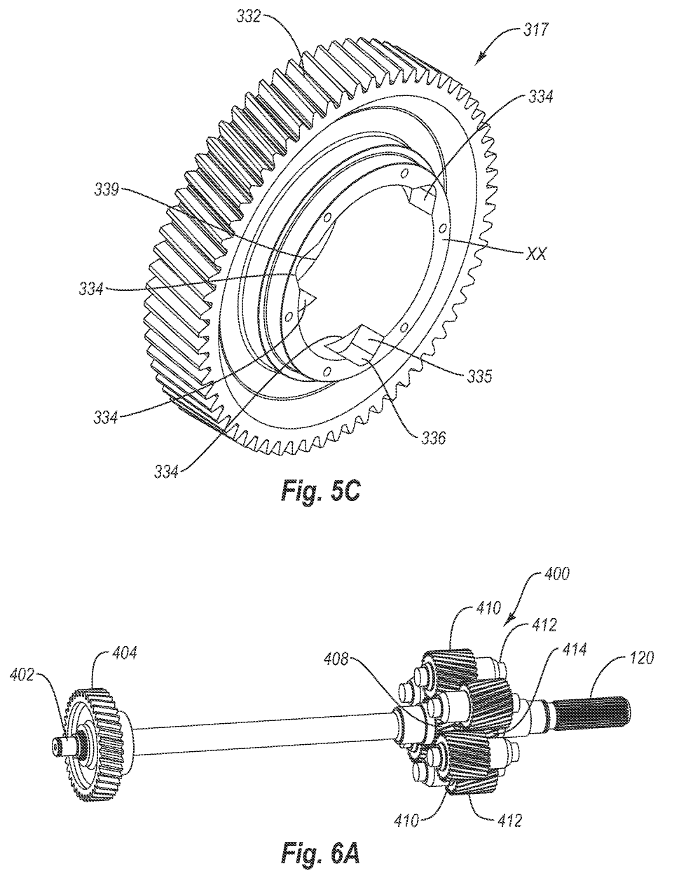

As noted previously, the example embodiment in FIGS. 4A and 4B can include multiple drive gears 312a-317b that are selectively locked or fixed to respective drive shafts 310a, 310b and/or trap shafts 322a, 322b. Turning now to FIGS. 5A and 5B, an exemplary mechanism is illustrated in greater detail as to one example embodiment of a device for selectively fixing one of multiple drive gears. It should be appreciated that while the example embodiment is described relative to fixing drive gears to a shaft, in other embodiments a similar mechanism may be used to additionally, or alternatively, lock driven gears to a shaft.

In FIG. 5A, a drive shaft 310 is illustrated and includes a collar 318 around which multiple drive gears 315-317 are positioned. In the illustrated embodiment, three drive gears 315-317 are included. Collar 318 could, however include additional drive gears. Indeed, in the illustrated embodiment, three additional drive gears could be included, but have been removed to more clearly illustrate the operation of drive shaft 310.

In the illustrated example, drive gears 315-317 are floating gears that sit on collar 318, but are generally free to float and/or rotate independent of collar 318. A locking mechanism may be used, however, to actuate one of the floating gears 315-317 in a manner that allows a single drive gear 315-317 to be actuated on each collar 318 at any given time. In this manner, as drive gears 315-317 engage driven gears 352-362 (FIGS. 4A, 4B), only the fixed drive gear 315-317 conveys power to the driven gears and provides an output, while the other, independent drive gears may continue to rotate without conveying power towards a transmission output.

Any suitable locking mechanism can be used to selectively actuate certain drive gears 315-317 at desired times. For example, a dog-clutch could be used in some embodiments. In the illustrated embodiment, however, an example locking mechanism is disclosed that does not make use of dog clutches. Instead, an alternative type of selection mechanism is provided in the form of drive shaft 310, and includes collar 318 operating in connection with trap shaft 322. In one example, the illustrated drive shaft 310 can provide selective locking of drive gears 315-317 while also being more compact than a dog clutch, thereby reducing the space requirements for use of the locking mechanism.

With reference now to FIGS. 5A and 5B, the drive shaft 310 of the illustrated embodiment makes use of a trap shaft 322 that is nested within collar 318. Trap shaft 322 may have a plurality of balls 418 that are positioned therein. In the illustrated embodiment, for instance, there may be twelve balls 324a-324c on one side of trap shaft 322; however, only six balls 324a-324c are illustrated inasmuch as the remaining balls are obscured by drive gears 315-317.

As shown in FIG. 5B, trap shaft 322 can have a plurality of balls 418 secured thereto and, as shown in FIG. 5A, collar 318 can have a plurality of openings 320a-320c that are configured to mate with balls 324a-324c. The balls 324a-324c and openings 320a-320c may both be positioned so as to correspond to the locations of drive gears 315-317. For example, in the illustrated embodiment, two balls 324a are configured to align with a drive gear that is positioned around two openings 320a defined by collar 318. Similarly, two balls 324b are configured to align with a drive (gear that may be positioned around openings 320b. Thus, each drive gear can cover two openings 320a-320c in collar 318, and align with corresponding, mating balls 324a-324c.

While the illustrated embodiment depicts a set of two balls 324a-324c and two openings 320a-b that can be aligned with each drive gear 315-317, it will be appreciated in view of the disclosure herein that this is merely exemplary. In other embodiments, more or fewer balls and/or openings may be used for each drive gear. For instance, a single ball may align with each drive gear, or three or more longitudinally spaced balls may align with each drive gear. Furthermore, while only a single set of balls 324a-c is illustrated for each drive gear, multiple additional balls 324a-324c may also be spaced circumferentially around trap shaft 322. For instance, three sets of two balls 324a-324c may each be spaced at one-hundred twenty degree intervals around the circumference of trap shaft 322.

It can be seen from the illustrated embodiment that the position of each set of balls 324a-324c that corresponds to a particular drive gear can be placed at a different circumferential location. For example, balls 324a may be at a circumferential position that is angularly offset relative to balls 324b and balls 324c. In the illustrated embodiment, trap shaft 322 has a helical configuration, with each ball being placed on a spline of the helix. Moreover, the greater the axial distance of balls 324b, 324c from balls 324a, the greater the angular offset relative to balls 324a. For instance, in the illustrated embodiment, balls 324b are angularly offset from balls 324a in a first direction, and angularly offset from balls 324c in a second direction. By way of example only, each successive set of balls 324a-324c may be positioned at an angular offset between about five and twenty degrees from immediately preceding and immediately subsequent balls 324a-324c.

While balls 324a-324c are angularly offset relative to each other, it can be seen in FIG. 4A that openings 320a-320c in collar 318 do not need to have a corresponding offset. Indeed, in the illustrated embodiment, collar 318 defines openings 320a-320c in a substantially straight line, where each of openings 320a-320c is approximately along a single longitudinal axis. In other embodiments, openings 320a-320c may also be angularly offset, although the need not correspond to the angular offset of balls 324a-324c on trap shaft 322. Additionally, where sets of balls 324a-324c are repeated circumferentially around trap shaft 322, collar 318 may have correspondingly repeated openings 320a-320c.

In general, trap shaft 322, balls 324a-324c and openings 320a-320c cooperate to selectively fix a single drive gear 315-317 to trap shaft 322 and collar 318. In particular, based on the angular and axial spacing of balls 324a-324c, and the positions of openings 320a-320c which are merely axially spaced, at any given angular position of collar 318 relative to trap shaft 322, only one set of balls 324a-324c can be positioned to correspond to a mating set of openings 320a-320c. For instance, if balls 324a are positioned to correspond to openings 320a, balls 324a-324c may press through openings 320c. Balls 324b, 324c, however, may not have a position that corresponds to the position of openings 320a, 320b, such that balls 324b, 324c may remain fully inside collar 318. Accordingly, the position of trap shaft 322 relative to collar 318 may be used in some embodiments to ensure that a desired drive gear 315-17 is fixed to trap shaft 322, and that no other drive gear 315-317 is inadvertently fixed to convey power from the power source to the load.

When balls 324a-324c are positioned such that they can align with a corresponding set of openings 320a-320c, balls 324a-324c may also contact and engage against corresponding drive gears 315-317. FIG. 5C, for example illustrates an example drive gear 317 that may be used to engage with balls 324a-324c so as to fix drive gear 317 to collar 318 and trap shaft 322. In FIG. 5C, drive gear 317 has a plurality of teeth 332 that may be configured to engage a corresponding driven gear. Additionally, a plurality of pockets 334 may be formed on each face 338, 339 of drive gear 317. For instance, the illustrated embodiment illustrates three pockets 334 formed on a first face 338 of gear 317. Three corresponding pockets 334 may also be found on an opposing face 339 of gear 317.

Pockets 334 may be machined or otherwise formed on faces 338, 339 of gear in any suitable manner, and can be sized such that one of balls 424a-424c (FIG. 5B) fits substantially tightly therein. In operation, and as described previously, the surface of collar 318 can have multiple openings 320a-320c that align with balls 324a-324c. Additionally, such openings 320a-320c may align with pockets 334 of gear 317. As a result, when balls 324a-324c align with openings 320a-320c, they can enter into pockets 334. Thus, as a ball 324a-324c, opening 320a-320c, and pocket 334 all come into alignment, the surface of collar 318 can drive balls 324a-324c into a corresponding pocket 334.

To facilitate entry of balls 324a-324c into pockets 334, each pocket may include a tapered entry 335. Tapered entry 335 is, in the illustrated embodiment, on an interior portion of gear 317, near the interior surface of gear 317, and mates with the interior surface connecting faces 338, 339. Entry 335 may be tapered to facilitate entry of balls 324a-324c. In particular, as gear 317 rotates, it may rotate such that pockets 334 align with balls 324a-324c of trap shaft 322. As balls 324a-324c come into contact with tapered entry 335, balls 324a-324c may roll along the taper of entry 335 and up into cavity 336 of pocket 334. Cavity 336 is sized to be approximately the size of balls 324a-324c so as to snugly maintain balls 324a-324c therein.

In some embodiments, it may thus be balls 324a-324c that primarily perform the function of locking gear 317 to collar 318 and/or trap shaft 322, and that such is performed by placing balls 324a-324c inside pockets 334. Such a system can provide the locking mechanism so that as the corresponding drive gear 315-317 is engaged by an output gear (e.g., output main gear 350 in FIGS. 3A and 3B), such an output gear can receive a power that is received from the transmission input, and thereby couple the load to the power source. As described previously, in some embodiments, multiple gears may be engaged at the same time, including during a gear ratio change, so constant engagement and positive displacement may be maintained not only at discrete gear ratios, but even during changes between gear ratios.

Further, in some embodiments, a bias or other securement mechanism may be placed on balls 324a-324c to help push balls 324a-324c through openings 320a-320c and into pockets 334 as well as to securely fix balls 324a-324c within pockets 334 while a load is transferred from drive gear 317 to a driven gear. Any suitable biasing mechanism may be used. For instance, in some embodiments, a spring may be used to bias balls 324a-324c outward relative to trap shaft 322. Such a biasing mechanism may, however, be overcome when balls 324a-324c are not aligned with a particular set of openings 320a-320c.

In other embodiments, hydraulic or pneumatic pressure may be used. According to one example embodiment, for instance, trap shaft 322 may have a channel formed therein through which oil or another relatively incompressible fluid is hydraulically pressurized. Because of the relative incompressibility of such a fluid, the pressure placed on the fluid can act on balls 324a-324c, and can push balls 324a-324c outward relative to trap shaft 322 and collar 18, and into position within pockets 334 of gear 317. In particular, the applied pressure can thus be used to exert a force on balls 324a-324c and not only push balls 324a-324c into position within pockets 334 when balls 324a-324c, openings 320a-320c, and gears 315-317 align, but can act as a force to maintain gears 315-317 at a generally fixed radial position, such that the rotational speed of a fixed gear 315-317 is approximately equal to the rotational speed of trap shaft 322 and/or collar 318.

Additionally, the oil or other fluid in some example embodiments can act as a lubricant so that collar 318 can freely rotate over the balls 418 that are not currently mating with a drive gear 315-317. Further, the bias imposed by any biasing mechanism may be selectively imposable so as to lock in place when the biasing mechanism is activated, but to release balls 324a-324c when the biasing mechanism is not necessary. For example, a pressurized system may apply pressure to lock collar 318 to a drive gear 315-317, and then release that pressure when a different drive gear 315-317 is being used to couple the power source to the load, thereby allowing balls 324a-324c to easily slip out of pockets 334 and to also disengage from openings 420a-420c within collar 318.

As will be appreciated in view of the disclosure herein, with an internal gear selection and locking mechanism such as drive shaft 310 described with reference to FIGS. 5A-5C, a considerable savings in space can be obtained with regard to the use of different gears. For instance, while using dog clutches can require sufficient space between each driven gear to place and operate the dog clutch, drive gears 315-317 could be positioned close enough to almost touch, and the need for additional components between drive gears 315-317 may be almost eliminated.

Any suitable manner and/or device(s) may also be used to rotate trap shaft 322 and/or collar 318 relative to the other so as to cause openings 320a-320c to line up with balls 324a-324c. For example, an electrical, mechanical, or electro-mechanical control system (not shown) could be implemented and selectively rotate trap shaft 322 to predetermined positions that provide alignment between certain of balls 324a-324c and openings 320a-320c. FIG. 4B illustrates one exemplary mechanism for facilitating such rotation of trap shaft 322 to facilitate selective locking of only one, desired drive gear 315-317. In particular, a linear displacement collar 326 is positioned on an end of trap shaft 322. Formed in such an end of trap shaft 322 are a plurality of grooves 328. Grooves 328 may be formed in trap shaft 322 in any suitable shape, and in the illustrated embodiment are generally curved and/or helical. Linear displacement collar 326 may include, for instance, pins or rollers 330 on an interior surface thereof that sit within grooves 328. As linear displacement collar 326 is moved axially with respect to trap shaft 322, the pins within grooves 328 are advanced or retreated relative to grooves 328. Due at least in part to the curved form of grooves 328, advancement or retreat of linear displacement collar 326 can thus cause trap shaft 324 to selectively rotate. The amount of rotation can be predetermined so as to determine which of a set of drive gears will be aligned with corresponding openings and/or locking balls.

Notably, as noted previously, the illustrated embodiment of drive shaft 310 is exemplary and while includes a single set of drive gears 315-317. As will be appreciated in view of the disclosure herein, one or more additional drive shafts 310 could also be used in connection with a power transmission system, so that one, two, three or more drive shafts 310 are used to convey power and couple a power source to a load. Additionally, where two or more drive shafts 310 are used, the multiple drive shafts 310 may each be operated independently, and can allow each of drive shafts 310 to have a drive gear locked at any particular time. During operation of transmission system, a drive gear of one of drive shafts 310 then be locked in place for use, and can engage a driven gear. As a gear ratio change is made, a control system may cause a drive gear on another drive shaft to lock in place and engage the same or a different driven gear. Moreover, as disclosed herein, there may be some overlap between the time of engagement of both gears, such that during the change between gears and gear ratios, constant engagement is maintained within the transmission system, thereby 1 causing the power source to remain connected to the load, even during a gear change. The amount and length of the simultaneous engagement can be a matter that can be selectively configured by the designer of the transmission to suit a desired application. For instance, by using an eccentric gear to facilitate a change between gear ratios and/or simultaneous engagement of multiple drive gears, the length of time two drive gears are simultaneously engaged with an output gear can be determined based on the rotational speed of the eccentric gear and/or the window provided by the eccentric gear during which speeds are reconciled.

It will also be appreciated in view of the disclosure herein that the specific embodiments disclosed herein are merely exemplary and that other embodiments are also contemplated and within the scope of the present invention. For instance, on the drive shaft 310 which uses balls to lock gears 315-317 in place, and thus operates as a ball gear selector, balls 324a-324c may be replaced with other locking elements that fix trap shaft 322 to collar 318 and/or drive gears 315-317. Additionally, while the illustrated example includes openings 320a-320c along a single longitudinal axis, openings 320a-320c could be angularly offset as well. Indeed, in some embodiments, balls 324a-324c could be positioned on a single linear axis while openings 320a-320c could be angularly offset.

In still other embodiments, the mechanism for causing selective rotation of trap shaft 322 relative to collar 318 may be modified or replaced. In one embodiment, for instance, linear displacement collar 336 may be secured to collar 318 and control rotation of collar 318. For instance, by advancing or retreating linear displacement collar 336, linear displacement collar 336 may rotate and thereby cause collar 318 to rotate a predetermined amount, and to a position in which balls 324a-324c are aligned with a corresponding set of openings 320a-320c.

Further still, while FIG. 5C discloses aspects of an example drive gear 317 with pockets 334 formed on outer faces 338, 339 thereof, in other embodiments, pockets 334 may be formed on an interior surface that does not intersect an outer face of drive gear 317. Thus, it should be appreciated that a wide variety of specific embodiments may be employed and which are within the scope of the present invention while further allowing a drive shaft 310 to selectively engage specific gears at appropriate times and positions, so as to maintain constant engagement, and optionally positive displacement, between drive and driven members of a transmission system, and thereby keeping a power source continuously connected to a load, even during changes in gear ratios. In this manner, drive shaft 310 can act as an engaged core that uses a ball gear selection mechanism to engage and connect the power source to the load.

In this manner, the ball gear selector 310 acts to selectively engage specific gears at appropriate times and maintain constant tooth-to-tooth engagement while keeping the power source continuously connected to the load. Thus, the ball gear selection mechanism can acts as an engaged core that maintains engagement and connection between a power source and a load. Accordingly, ball gear selector 310, and drive shafts 310a, 310b, as well as output system 300 are each examples of physical implementations for selectively engaging one or more gears, and also means for maintaining constant engagement while changing gear ratios.

### 6. Reverse Differential System

Returning briefly to FIGS. 1A and 1B, example transmission 100 is disclosed and includes a transmission input 110 that provides an input through one or more phase shifting assemblies 200a, 200b as well as to a reverse differential system 400. In particular, the illustrated embodiment includes a splitting gear 112 that splits the received power and torque along three torque paths, although more or fewer torque paths may be used. As described previously, two torque paths are provided by which splitting gear 112 transfers power through phase shifting assemblies 200a, 200b. A third torque path is provided by engaging splitting gear 112 with a first transfer gear 116. First transfer gear 116 is coupled to a transfer shaft 118 and a second transfer gear 120, such that as splitting gear 112 receives the power input, it rotates first transfer gear 116, which in turn causes transfer shaft 118 and second transfer gear 120 to rotate.

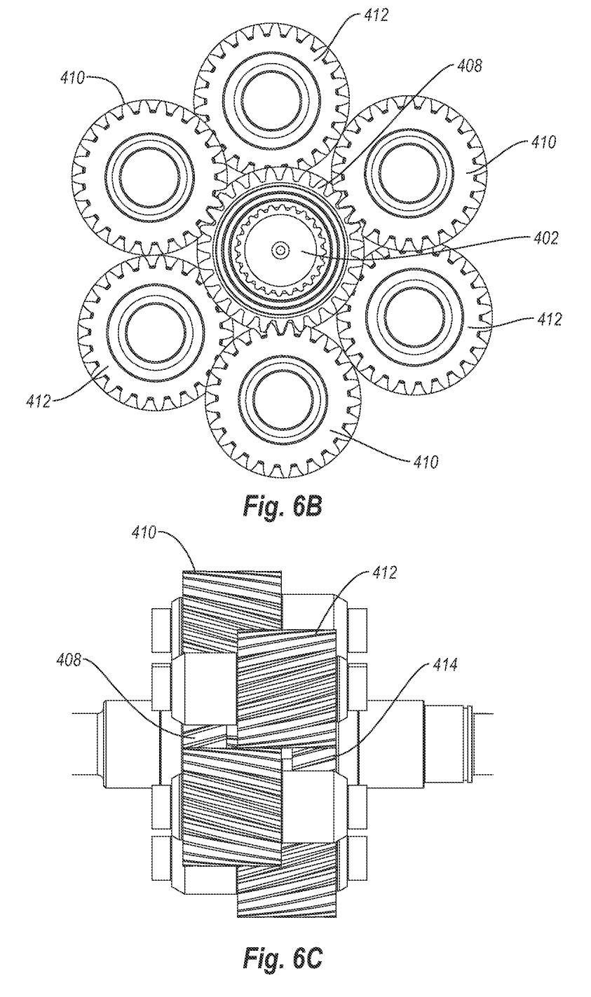

Second transfer gear 120 may in turn engage a differential linking gear 404 that is best illustrated in FIG. 6A. Second transfer gear 120 may engage differential linking gear 404 directly, although in other embodiments second transfer gear 120 indirectly engages differential linking gear 404 through one or more additional gears, chains, or other members.

Any suitable gear ratio may be utilized between second transfer gear 120 and differential linking gear 404, although in some embodiments a 1:1 ratio is used. In operation, differential linking gear 404 is coupled to differential input shaft 402 such that the rotation of differential linking gear 404 is also transferred to differential input shaft 402. Any suitable connection may be used. For example, a splined connection may be used to connect differential linking gear 404 and differential input shaft 402, or differential linking gear 404 may be integrally formed or welded to differential input shaft. In other embodiments, one or more gears or gear trains may indirectly couple differential input shaft to differential linking gear 404.

FIGS. 6B and 6C provide an enlarged view of various elements of reverse differential system 400. In particular, FIG. 6B provides a frontal view in which differential linking gear 404 has been omitted to more clearly illustrate the operation of various other elements within reverse differential system 400. FIG. 6C provides a side view of the components illustrated in FIG. 6B. Additionally, FIGS. 6A-6C all illustrate a reverse differential system 400 such as that in FIG. 3B, but with housing 406 removed to more clearly illustrate internal components of reverse differential system 400.

As can be seen from the embodiment in FIGS. 6A-6C, differential input shaft 402 may also be coupled to a differential sun gear 408 that is configured to be rotated by shaft 402. For example, as shaft 402 rotates in a first direction (e.g., counterclockwise) at a certain rotational speed, differential sun gear 408 can also rotate in the first direction, at a corresponding rotational speed. As shown in FIGS. 6B and 6C, differential sun gear 408 can be positioned within a cluster of gears and can act as a first input into reverse differential system 400.

As also described previously and illustrated in FIG. 3B, a transmission that includes optional reverse differential system 400 may have an output from an output system 300. That output, in the example embodiment in FIGS. 3A, 3B, can be received at output main gear 350 as output main gear 350 is rotated by one or both of drive shafts 310a, 310b. In the embodiment illustrated in FIG. 3B, output main gear 350 is coupled to a housing 406 of reverse differential system 400. Thus, as output main gear 350 rotates, housing 406 is also caused to rotate. As described in more detail hereafter, housing 406 may provide a second input into reverse differential system 400.

Differential system 400, in the illustrated embodiments, can provide a variety of features, one of which may be an engaged neutral by which a transmission input remains connected to a load, despite providing zero output. In other embodiments, differential system 400 may, however, merely provide additional gear ratios and need not specifically provide an engaged neutral feature.

As will be appreciated by one skilled in the art in view of the disclosure herein, reverse differential system 400 can include a differential, but such differential does not necessarily operate in the same manner as a typical differential as might be found in an automotive or other power transmission system. For example, in a typical differential in an automotive system, a differential may be used in the final drive on an axle of the vehicle. On the axle, a single input may interconnect with two outputs so as to provide outputs to each axle on a front drive. The illustrated reverse differential system 400, however, operates in a different manner and, in many regards, opposite the described typical differential.

Specifically, and as noted previously, the illustrated embodiment includes two inputs 406, 408. Moreover, the two inputs, namely input from differential sun gear 408 and from housing 406 can be combined to provide a single output 120. Furthermore, the inputs may be rotational and can be in any direction. For instance, differential sun gear 408 may rotate clockwise or counterclockwise, and housing 406 may rotate clockwise or counterclockwise.

In one embodiment, differential sun gear 408 and housing 406 provide inputs in the same direction (e.g., counterclockwise). Additionally, housing 406 may have multiple gears secured thereto, or therewithin. For instance, a set of one or more planet gears 410 may be connected to housing 406 and can engage differential sun gear 408. In one embodiment, differential sun gear 408 is approximately centered within housing 406, and, as best illustrated in FIG. 6B (which has housing 406 removed to provide a better view of gears 408, 410 and 412 that may be within housing 406), planet gears 410 may each not be centered within housing 406, but may instead be angularly spaced around a longitudinal axis on which housing 406 and/or differential sun gear 408 are centered. The positioning of planet gears 410 in the illustrated embodiment is such that as housing 406 rotates, planet gears 410 orbit around differential sun gear 408. Inasmuch as differential sun gear 408 mates with each of planet gears 410, the orbital motion of planet gears 410 around differential sun gear 408 can thus cause planet gears 410 to rotate under some circumstances, as described in greater detail herein. Planet gears 410 may also engage a moon gears 418 that orbit with housing 406. As planet gears 410 thus orbit, and optionally rotate, it will be appreciated that the engagement of planet gears 410 to moon gears 412 may also cause moon gears to rotate in addition to the orbital motion moon gears 412 may already have by virtue of a connection through housing 406.

A differential output gear 414 is, in the illustrated embodiment, is secured to housing 406 and engages moon gears 412. In this manner, as moon gears 412 orbit around differential output gear 414, and as they optionally rotate, moon gears 412 can transfer power to differential output gear 414. Differential output gear 414 may, in turn, be connected to an output shaft which may be transmission output 120, or may be coupled to transmission output 120.

In the example described manner, there may thus be two different inputs provided to differential system 400, and the two inputs may be combined into a single output at differential output gear 414. Additionally, based on the directions and magnitudes of such inputs, the inputs may have an additive or subtractive effect within differential system 400. For example, it will be appreciated that through gear ratios, input from a transmission input can be provided and transferred such that differential sun gear 408 rotates in a first direction (e.g., counterclockwise). Through additional, appropriate gearing, the rotation of an output system such as output system 300 in FIGS. 3A and 3B may also be transferred to housing 406 so that housing 406 rotates in the same direction (e.g., counterclockwise), although differential sun gear 408 and housing 406 may, in other embodiments, provide inputs that are in opposite directions. In reverse differential system 400 as illustrated in FIGS. 6A-6C, variations to the respective magnitudes and/or directions of rotational inputs provided by differential sun gear 408 and housing 406 can ultimately provide a variety of different outputs at transmission output 120, including a reverse, neutral, drive and overdrive for a transmission. Thus, two inputs can combine to provide an aggregate clockwise or counterclockwise rotation of varying speeds, or even to provide no aggregate output.

More particularly, as differential sun gear 408 rotates, housing 406 may also be rotating and thereby causing planet gears 410 to orbit around differential sun gear 408 in the same direction. At mating gears, the velocity of the gear teeth at the point of engagement must be equal as to direction and magnitude. Further, the velocity of gear teeth is related to the rotational and/orbital motion by the equation V=r·ω, where V is the linear velocity, r is the radius of rotation at the point of engagement, and φ is the angular velocity.

Thus, consider the gears in FIG. 6B, which illustrate an example differential sun gear 408 which is provided an input such that it rotates about its own axis. A second input can be provided through housing 406 that causes planet gears 410 to orbit around the central, longitudinal axis of differential sun gear 408 and/or housing 406. In such an example, the radius of the orbit of planet gears 410 at the point of engagement between planet gears 410 and differential sun gear 408 is equal to the radius of rotation of differential sun gear 408 inasmuch as the orbital motion of planet gears 410 and the rotational motion of differential sun gear 408 are centered on the same axis. Accordingly, if the angular velocity of rotating differential sun gear 408 is equal to the angular velocity of orbiting planet gears 410, the linear velocities (V₄₀₆ and V₄₁₀) are also equal at the point of engagement. Inasmuch as V₄₀₈=V₄₁₀, the introduction of any other velocity to one of differential sun gear 408 or to planet gears 410 could cause an inequality at the point where the teeth on differential sun gear 408 mate with the teeth on planet gears 410. For example, if planet gears 410 were to not only orbit around differential sun gear 408, but also to rotate about their own, internal axis, the internal rotation of planet gears would also contribute to the velocity of planet gears 410 at the point of contact. In a circumstance where the angular velocity of a rotating differential sun gear 408 is equal to the angular velocity of orbiting planet gears 410, such contribution would create an inequality between V₄₀₈ and V₄₁₀. Accordingly, to maintain an equality in the velocities of gear teeth at the point of contact, there can be no velocity contribution by the internal rotation of moon gear 416 about its own axis. In other words, angular velocities of orbiting planet gears 410 and rotating differential sun gear 408 that are equal in magnitude and direction may result in planet gears 410 having no internal rotation as they orbit around differential sun gear 408.

Where the magnitude and/or direction of the orbital motion of planet gears 410 is not equal to the rotational motion of differential sun gear 408, other interesting output scenarios may be obtained by reverse differential system 400. For example, consider a circumstance in which differential sun gear 408 rotates at an angular velocity less than the angular velocity at which planet gears 410 orbit. In such a case, the velocity of the teeth of sun gear 408 at the points of engagement is less than the velocity component provided by the orbital angular velocity of planet gears 410. There is thus an inequality in V₄₀₈ and V₄₁₀.

To compensate for the inequality in velocities, planet gears 410 are caused to rotate about their internal axes to provide a compensating velocity component. Moreover, because V₄₁₀ is greater than V₄₀₈, the velocity component is in the opposite direction. Such may be obtained by, for example, planet gears rotating in the same direction as both housing 406 and differential sun gear 408, and at a rotational speed that provides a velocity component that is equal in magnitude to the difference between V₄₁₀ and V₄₀₈. Thus, inequalities of linear velocities generated by the rotational motion of differential sun gear 408 and the orbital motion of planet gears 410 can cause planet gears 410 to rotate and provide an additional velocity component. That additional velocity component is the difference between velocity components produced by the respective orbital motion of planet gears 406 and the rotation motion of differential sun gear 408.

Under this same relationship, it will be appreciated that when housing 406 and differential sun gear 408 rotate in the same direction, and the angular velocity of differential sun gear 408 is greater than the angular velocity of housing 406, there is another velocity inequality that causes planet gears 410 to rotate. In that situation, the rotation of planet gears 410 may produce a velocity component that when added to the velocity component caused by the orbit of planet gears 410, is equal to the velocity of differential sun gear 408 at the points of engagement. The velocity component may thus be generated in the same direction as the velocity components generated by the orbital motion of housing 406 and the rotation of differential sun gear 408, which results in an internal rotation of planet gears 410 in a direction opposite the direction of rotation of differential sun gear 408 and opposite the direction in which housing 406 rotates.

Notably, if planet gears 410 rotate in a first direction (e.g., counterclockwise), the example embodiment shown in FIGS. 6A-6C, in which planet gears 410 are helical gears that mate with helical moon gears 410, may result in moon gears 412 rotating in an opposite direction (e.g., clockwise). In a manner similar to that described above relative to planet gears 410 and input sun gear 408, the orbital and rotational motions of moon gears 412 can then be combined to provide cause differential output gear 414 to rotate and provide an output to transmission output 120. Indeed, if the radii of gears 408, 410, 412 and 414 are all equal, the output of differential output gear can be related to the inputs of differential sun gear 408 and housing 406 by the following equation: ω₄₁₄=2ω₄₀₆−ω₄₀₈.

Using the equation for ω₄₁₄, it is evident that a variety of magnitudes and directions of the output at transmission output 120 may be obtained by varying the input rotational speed of differential sun gear 408 and the rotational speed of housing 406. For instance, if housing 406 and differential sun gear 408 rotate in the same direction, and at the same speed, differential output gear 414 may also rotate at the same speed and in the same direction. In contrast, if differential sun gear 408 rotates in the same direction as housing 406, but at three times the speed of housing 406, differential output gear 414 will have a rotation equal in magnitude to the rotation of housing 406, but opposite in direction.

In still another example, if differential sun gear 408 rotates in the same direction as housing 406, but at twice the speed of housing 406, differential output gear 414 will have no internal rotation. That is to say that when the orbital motion of moon gears 414 are combined with the rotational motion of moon gears 414, such motions can completely offset each other so that moon gears 414 continue to orbit around differential output gear 414, but provide no output to differential output gear. Accordingly, a transmission may maintain a connection between the power source and the load, but provide zero output to transmission output 120. Indeed, the zero output may effectively act as brake that prevents coasting of the load relative to the power source.

One feature of the disclosed differential system 400 is thus the ability to start power transmission, from a dead stop, and with constant engagement. For instance, a vehicle with a high torque engine (e.g., a semi-tractor trailer) may be stopped in an engaged neutral on a road with a steep incline. With the above described differential system 400, such a vehicle can maintain engagement while stopped and, then when it begins to move the load, the load can be moved by the transmission gearing up from neutral, while maintaining engagement and in very small, and possibly infinitely small increments. This can allow the load to be moved incrementally, and without coasting. In particular, infinitely small increments of change can be used to cause the vehicle to move, such that there is little to no rollback when starting the movement, and the infinitely small increments of change can also reduce a torque spike that may otherwise occur when engaging the engine. Of course other control systems such as fuses, governors, and the like can also be used with the power transmission system to reduce the chance of an operator inadvertently creating a large torque spike by, for example, too quickly moving through gear ratios.

With continued reference to FIGS. 6A-6C, it should thus be appreciated in view of the disclosure herein that that by varying the relationship between the rotational speed inputs at housing 406 and differential sun gear 408 (e.g., by varying gear ratios using phase shifting assemblies 200a, 200b and/or using output system 300 in FIG. 1A), a wide variety of outputs can be received. Moreover the varied outputs can operate to provide reverse, engaged neutral, drive and overdrive gears. Further still, such a transmission may even operate at a constant input velocity, and such differing outputs can be obtained by varying the output on housing 406 relative to the constant input of the transmission.

It should be appreciated that the foregoing example embodiments and illustrations are merely exemplary, and that other configurations can exist. For instance, in some embodiments, moon gears 418 within housing 406 may be eliminated entirely, or additional moon or other gears can be provided. Furthermore, gears within housing 406 may be different sizes and the above relationship relating the angular velocity of differential output gear to the input angular velocities of the housing 406 and differential sun gear 408 (i.e., ω₄₁₄=2ω₄₀₆−ω₄₀₈). In still other embodiments, the input may even be disconnected and allowed to rotate freely, or held with zero internal rotation. In still other embodiments, input gear 406 and housing 406 may receive inputs in opposite directions. Additionally, while the illustrated embodiment includes three planet gears 410 and three moon gears 412 that are each equally angularly spaced around a central axis of housing 406, other embodiments may employ a single planet gear 410 and a single moon gear 412, or more or less than three planet gears 410 and/or moon gears 412.

Indeed, in all regards, the embodiments described above with respect to reverse differential system 400 as well as transmission 100 are illustrative, and one skilled in the art will appreciate that various alternatives and/or additional components may be utilized. In some regards, for example, gears may be removed or added to provide additional gear ratio changes, and/or to link inputs or outputs to other components. In one embodiment, for instance, housing 406 may be indirectly coupled to output main gear 406 by way of one or more transfer gears. Additionally, gears and/or shafts within housing 406 and transmission 100 may be installed using bearings to facilitate rotation thereof. For example, moon gears 412, planet gears 410, and/or differential output gear 414 may be connected to housing 406 by using bearings that allow internal rotation of gears 410, 412, and 414.

The configuration of reverse differential assembly 400 can thus be useful for any number of different types of power transfer components and may, for example, be used to provide an engaged neutral and/or to combine two inputs into a single output. Thus, reverse differential system 400 is an example of a physical implementation of a means for providing an engaged neutral, as well as a means for combining inputs, and a means for providing an aggregate output.

Further, while the example embodiment described above includes a first input from differential input gear 408 that receives its power from the transmission input and combines it with an output from a transmission output system, this too is a merely exemplary. For example, first and second inputs can be provided through totally independent sources of power. For instance, the first and/or second inputs can be turbine engines, internal combustion engines, electric motors, or any other suitable input system. Additionally, the amount of load carried by each power supply can be determined by the ratio between the two inputs within the reverse differential.

Additionally, where two separate power sources are used for the inputs to reverse differential system 400, a secondary power supply may optionally be engineered to shut down, thereby allowing the second input (which itself may be geared for overdrive) to run straight from a primary power supply to the load. Such a system may improve the efficiency to exceed that of even the standard transmission.

Of course, in other embodiments, the first and second inputs to reverse differential system 400 can be provided from a single power source. For instance, the first input may be received from a splitter that transmits power from the transmission input, while the second power source transmits power from a transmission output system. The use of a splitter at or near the transmission input may itself also provide a variety of desirable features. For example, by splitting the received power, torque can be reduced through load bearing elements of the system and then combined later in the system. By reducing the torque, the wear, heat, friction, and the like can be reduced thereby improving the life of the transmission and/or allowing smaller, lighter, and/or less expensive components to be utilized.

Regardless of the particular implementation, the types of transmissions usable in any such event would include, but not be limited to: manual, automatic, belt-driven CVT, toroidal CVT, PECVT, hydraulic pump/motor transmissions, and essentially any other type of transmission. Moreover, the configuration using reverse differential system 400 can provide for many variables between the velocity of an engine and the ratio of the transmission. The variables could be engineered to, for instance, favor peak power, peak fuel economy, operating speed of an electric or other motor, and the like. As a result, a transmission and/or reverse differential as described herein lends itself to a wide range of applications, and can be scalable for virtually any type of application by virtue of the constant engagement and/or positive displacement provided.

Embodiments disclosed herein can thus related to various elements of a transmission, and can include components, assemblies, systems and subsystems of a transmission or other power transfer device. For instance, while various embodiments are disclosed herein as being illustrative of a transmission, the same device can operate as a mechanical clutch. Thus, nothing herein should limit principles of operation herein to only transmissions.

Further, while various components are described herein in the context of an entire power transfer system, many components, assemblies, and systems can be used independent of the specific embodiments used herein. For example, drive shafts 310a, 310b described herein in connection with the ball gear selector may be used in a power transfer system irrespective of whether phase shifters, reverse differentials, or the like are utilized. Similarly, reverse differential systems described herein may also be used on virtually any power transfers system, and need not be used in connection with any specific combination of elements disclosed herein.

Control and Design Systems

As discussed herein, various components and/or assemblies may be controlled and or selectively operated to produce a desired output. For example, carrier shaft control gear 263a and eccentric control gears 210a, 210b can be selectively engaged and/or actuated to produce desired effects. Eccentric control gears 210a, 210b, for example, may be rotated by another division of the input power, and can optionally rotate at the same speed as the input. The eccentric control gears could, however, only be actuated on an as-needed or other selective basis by, for example, using software, electrical components, mechanical intelligence systems, or other elements that operate to selectively control activation. Carrier shaft control gear 263a may similarly be selectively activated to move follower assemblies 250a, 250b to obtain a desired phase for an output.

Such control systems, whether implemented in software, electrical components, mechanical components, or a combination thereof, can also be used to control the selective activation of desired drive gears on drive shafts 310a, 310b. In some embodiments, the selective fixing and unfixing of engaged and to-be-engaged gears can be controlled by the same control system managing control of phase shifting assemblies 200a, 200b, although this need not be the case. By synchronizing control of the phase shifting assemblies 200a, 200b and drive shafts 310a, 310b, whether by the same or different control systems, constant engagement can be maintained during a gear ratio change, thereby providing transmission 100 with positive displacement and a constant connection from the power source to the load.

Furthermore, each of the gears, systems, assemblies, transmissions, and other components herein can be designed for use with a particular application, and can be scalable and changeable based on the particular application. Various elements of the system are variable and can be changed. By way of example only, the numbers of drive and driven gears, the size of gears, the overall range of gear ratios provided by the transmission, and the like are changeable. Using software that embodies the principles set forth herein, including the equations in the Appendix, various elements of a system for transmitting power in accordance with the systems herein can be designed. For instance, a software program that incorporates the equations in the Appendix to provide the design and/or manufacturing of an eccentric gear with a hybrid tooth profile may be used, although such a software program could include many additional or alternative elements as well.

The disclosure herein includes numerous specific examples; however, such examples are presented merely to illustrate aspects of the present invention, and are not intended to indicate that any components must be used, or must be used with any other combination of components. Any alternative disclosed herein is contemplated for use with other elements and alternatives described or suggested.

The present invention may be embodied in other specific forms without departing from its spirit or essential characteristics. The described embodiments are to be considered in all respects only as illustrative and not restrictive. The scope of the invention is, therefore, indicated by the appended and later added or amended claims rather than by the foregoing description. All changes which come within the meaning and range of equivalency of the claims are to be embraced within their scope.

### 8. Appendix

Depending on the hybrid profile to be used with a gear tooth, if any at all, the formulas may look very different. The formulas, descriptions and code included in this section are representative of one example hybrid tooth profile. One set of example formulas are described in this Appendix section to highlight an example hybrid tooth profile. A hybrid profile as described by the equations herein may be based on standard involutometry equations but, as will be appreciated by one skilled in the art, may also be based on circumstances not present in standard involutometry equations, such as the effect of a varying base circle radius around a perimeter of all, or a portion of, a gear tooth. A more particular discussion of the equations and variables in this Appendix can be found in U.S. Application Ser. No. 61/195,457, filed on Oct. 6, 2008, and entitled “CONCEPTUAL DESIGN AND ANALYSIS OF A POSITIVELY ENGAGED CONTINUOUSLY VARIABLE TRANSMISSION.”

A. Equations for Calculating a Hybrid Gear Profile

### Standard Involutometry Equations

$$\begin{matrix}{P}_{c} = \frac{π \cdot d}{N} & ( 1 ) \\ {P}_{d} = \frac{N}{d} & ( 2 ) \\ {P}_{c} = \frac{π}{{P}_{d}} & ( 3 ) \\ R = \frac{{d}_{input}}{{d}_{output}} & ( 4 )\end{matrix}$$

### Subtended Arc Equation

$$β = \frac{\sqrt{{r}_{inv}^{2} - {r}_{b}^{2}}}{{r}_{b}} \qquad ( 5 )$$

### Vectorial Angle Equations

$$\begin{matrix}θ = β - {tan}^{- 1} \frac{\sqrt{{r}_{inv}^{2} - {r}_{b}^{2}}}{{r}_{b}} = β - ϕ & ( 6 ) \\ θ = tan ϕ - ϕ - inv ϕ & ( 7 )\end{matrix}$$

### Radius of Curvature Equations

r_{c}=r_{b}β (8)

r_{c}=r_{b} tan φ (9)

### Radius of Involute Form Equation

rᵢₙᵥ(φ)=\sqrt{r_{b}²+r_{c}²} (10)

### Path of Contact Equations

$$\begin{matrix}y = {r}_{inv} \cdot cos {θ}^{′} & ( 11 ) \\ {x}_{p} = \frac{- y}{tan ϕ} & ( 12 )\end{matrix}$$

### Fundamental Law of Gearing Equations

$$\begin{matrix}{ω}_{out} = {ω}_{i n} \frac{{r}_{i n}}{{r}_{out}} & ( 13 ) \\ {v}_{t} = {r}_{inv} \cdot ω & ( 14 ) \\ \vec{{v}_{n}} = \vec{{v}_{{N}_{input}}} = \vec{{v}_{{N}_{ouput}}} = \vec{{v}_{loa}} = constant & ( 15 )\end{matrix}$$

### Circular Tooth Thickness Equation

$${T}_{p} = \frac{π}{2 \cdot {D}_{p}} \qquad ( 16 )$$

### Involutometry Equations for Initial Pinion Involute Profile

$$\begin{matrix}{r}_{{pp}_{o}} = \frac{{N}_{{p}_{o}}}{2 \cdot {D}_{p}} & ( 17 ) \\ {r}_{{ap}_{o}} = {r}_{{pp}_{o}} + \frac{1}{{D}_{p }} & ( 18 ) \\ {r}_{{bp}_{o}} = {r}_{{pp}_{o}} \cdot cos {ϕ}_{p} & ( 19 )\end{matrix}$$

### Involutometry Equations for Final Pinion Involute Profile

$$\begin{matrix}{r}_{{pp}_{f}} = \frac{{N}_{{p}_{f}}}{2 \cdot {D}_{jp}} & ( 20 ) \\ {r}_{{ap}_{f}} = {r}_{{pp}_{f}} + \frac{1}{{D}_{p}} & ( 21 ) \\ {r}_{{bp}_{f}} = {r}_{{pp}_{f}} \cdot cos {ϕ}_{p} & ( 22 )\end{matrix}$$

### Ring Gear Involutometry Equations

$$\begin{matrix}{r}_{pr} = \frac{{N}_{r}}{2 \cdot {D}_{p}} & ( 23 ) \\ {r}_{ar} = {r}_{pr} + \frac{1}{{D}_{p}} & ( 24 ) \\ {r}_{br} = {r}_{pr} \cdot cos {ϕ}_{p} & ( 25 ) \\ {r}_{ir} = \frac{( {N}_{r} - 1.2 )}{2 \cdot {D}_{p }} & ( 26 ) \\ {ω}_{{r}_{o}} = {ω}_{{p}_{o }} \cdot \frac{{r}_{{pp}_{o}}}{{r}_{pr}} & ( 27 ) \\ {ω}_{{r}_{f}} = {ω}_{{p}_{f}} \cdot \frac{{r}_{{pp}_{f}}}{{r}_{pr}} & ( 28 )\end{matrix}$$

### Lengths of Contact and Angles of Engagement Equations

$$\begin{matrix}{L}_{a} = {r}_{pr} \cdot sin ( {ϕ}_{p} ) - \sqrt{{r}_{ir}^{2} - {r}_{br}^{2}} & ( 29 ) \\ {η}_{a} = {cos}^{- 1} ( \frac{- {L}_{a} + {r}_{ir}^{2} + {r}_{pr}^{2}}{2 \cdot {r}_{ir} \cdot {r}_{pr}} ) & ( 30 )\end{matrix}$$

### Lengths of Contact and Angles of Engagement Equations at Initial Pinion Profile

$$\begin{matrix}{L}_{{a}_{o}} = {r}_{pr} \cdot sin ( {ϕ}_{p} ) - \sqrt{{r}_{ir}^{2} - {r}_{br}^{2}} & ( 31 ) \\ {η}_{{a}_{o }} = {cos}^{- 1} ( \frac{- {L}_{{a}_{o}} + {r}_{ir}^{2} + {r}_{br}^{2}}{2 \cdot {r}_{ir} \cdot {r}_{pr}} ) & ( 32 ) \\ {L}_{{r}_{o}} = \sqrt{{r}_{{ap}_{o}}^{2} - {r}_{{bp}_{o}}^{2}} - {r}_{{pp}_{o}} \cdot sin ( {ϕ}_{p} ) & ( 33 ) \\ {r}_{{ic}_{o}} = \sqrt{{r}_{pr}^{2} + {L}_{{r}_{o }}^{2} - 2 \cdot {r}_{pr} \cdot {L}_{{r}_{o }} \cdot cos ( {ϕ}_{p} + π / 2 )} & ( 34 ) \\ {η}_{{r}_{o}} = {cos}^{- 1} ( \frac{- {L}_{{r}_{o}} + {r}_{{ic}_{o}}^{2} + {r}_{pr}^{2}}{2 \cdot {r}_{{ic}_{o}} \cdot {r}_{pr}} ) & ( 35 )\end{matrix}$$

### Lengths of Contact and Angles of Engagement Equations at Final Pinion Profile

$$\begin{matrix}{L}_{{a}_{f}} = {r}_{pr} \cdot sin ( {ϕ}_{p} ) - \sqrt{{r}_{ir}^{2} - {r}_{br}^{2}} & ( 36 ) \\ {η}_{{a}_{f}} = {cos}^{- 1} ( \frac{- {L}_{{a}_{f}} + {r}_{ir}^{2} + {r}_{pr}^{2}}{2 \cdot {r}_{ir} \cdot {r}_{pr}} ) & ( 37 ) \\ {L}_{{r}_{f}} = \sqrt{{r}_{{ap}_{f}}^{2} - {r}_{{bp}_{f}}^{2}} - {r}_{{pp}_{f}} \cdot sin ( {ϕ}_{p} ) & ( 38 ) \\ {r}_{{ic}_{f}} = \sqrt{{r}_{pr}^{2} + {L}_{{r}_{f}}^{2} - 2 \cdot {r}_{pr} \cdot {L}_{{r}_{f}} \cdot cos ( {ϕ}_{g} + π / 2 )} & ( 39 ) \\ {η}_{{r}_{f}} = {cos}^{- 1} ( \frac{- {L}_{{r}_{f}} + {r}_{{ic}_{f}}^{2} + {r}_{pr}^{2}}{2 \cdot {r}_{{ic}_{f}} \cdot {r}_{pr}} ) & ( 40 )\end{matrix}$$

### Incremental Time Equation

$$t = \frac{{L}_{a} {L}_{r}}{{ω}_{r} \cdot {r}_{br}} \qquad ( 41 )$$

### Initial Pinion Time Increment Equation

$${t}_{o} = \frac{{L}_{{a}_{o}} + {L}_{{r}_{o}}}{{ω}_{{r}_{o}} \cdot {r}_{br}} \qquad ( 42 )$$

### Hybrid Involute Profile Pinion Time Increment Equations

$${t}_{f} = \frac{{L}_{{a}_{f}} + {L}_{{r}_{f}}}{{ω}_{r} \cdot {r}_{br}} \qquad ( 48 )$$

### Final Pinion Time Increment Equation

$$\begin{matrix}\vec{{v}_{f}} = \vec{{A}_{pc}} \cdot {t}_{h} + \vec{{v}_{o}} & ( 43 ) \\ \vec{{P}_{pc}} = \vec{{A}_{pc}} \cdot \frac{{t}_{h}}{2} - \vec{{v}_{o}} \cdot {t}_{h} + \vec{{P}_{o}} & ( 44 ) \\ \vec{{v}_{f}} = {ω}_{{r}_{f}} \cdot {r}_{br} & ( 45 ) \\ \vec{{v}_{o}} = {ω}_{{r}_{o}} \cdot {r}_{br} & ( 46 ) \\ \vec{{P}_{pc}} = {L}_{{a}_{o}} + {L}_{{r}_{f}} & ( 47 )\end{matrix}$$

### Radii of Contact Equations

$$\begin{matrix}\vec{{V}_{o}} = {ω}_{r} \cdot {r}_{br} \cdot i \cdot {e}^{i \cdot {ϕ}_{p}} & ( 49 ) \\ \vec{{V}_{pc}} = \vert \vec{{V}_{o}} \vert \cdot {e}^{i \cdot ψ} & ( 50 ) \\ ψ = {ϕ}_{p} - \frac{π}{2} & ( 51 ) \\ \vec{{P}_{pc}} = \int \vec{{V}_{pc}} \cdot d t & ( 52 ) \\ \vec{{P}_{pc}} = \vec{{V}_{pc}} \cdot t + \vec{{P}_{o}} & ( 53 ) \\ \vec{{r}_{{inv}_{r}}} = {r}_{ir} \cdot {e}^{i \cdot {η}_{a}} + \vec{{P}_{pc}} & ( 54 ) \\ \vec{CD} = ( {r}_{pr} - {r}_{pp} ) \cdot {e}^{i \cdot 0} & ( 55 ) \\ \vec{{r}_{{inv}_{p}}} = \vec{{r}_{{inv}_{r}}} - \vec{CD} & ( 56 )\end{matrix}$$

### Initial Pinion Radii of Contact Equations

\vec{Vₒ_{ₒ}}=ωᵣ_{ₒ}·r_{br}·i·e^{i·φ}^{ₚ} (57)

\vec{V_{pc}_{ₒ}}=|\vec{Vₒ_{ₒ}}|·e^{i·ψ} (58)

\vec{P_{pc}_{ₒ}}=\vec{V_{pc}_{ₒ}}·t+\vec{Pₒ} (59)

{right arrow over (rᵢₙᵥ_{_{r o}})}=rᵢᵣ·e^{i·η}^{_{αf}}+\vec{P_{pc}_{ₒ}} (60)

{right arrow over (rᵢₙᵥ _{_{p o}})}={right arrow over (rᵢₙᵥ_{_{r o}})}−\vec{CD} (61)

### Hybrid Involute Profile Pinion Radii of Contact Equations

$$\begin{matrix}\vec{{V}_{{o}_{h }}} = {ω}_{{r}_{o}} \cdot {r}_{br} \cdot i \cdot {e}^{i \cdot {ϕ}_{p}} & ( 62 ) \\ \vec{{V}_{{pc}_{h }}} = \vec{{A}_{pc}} \cdot t + \vec{{V}_{{o}_{•}}} & ( 63 ) \\ \vec{{P}_{{pc}_{h}}} = \int ( \vec{{A}_{pc}} \cdot t + \vec{{V}_{{o}_{•}}} ) \cdot d t & ( 64 ) \\ \vec{{P}_{{pc}_{h}}} = \frac{\vec{{A}_{pc}} \cdot {t}^{2}}{2} + \vec{{V}_{{o}_{•}}} \cdot t + \vec{{P}_{o}} & ( 65 ) \\ \vec{{r}_{{inv}_{{r}_{h}}}} = {r}_{ir} \cdot {e}^{i \cdot {η}_{{a}_{o}}} + \vec{{P}_{{pc}_{o}}} & ( 66 ) \\ {ω}_{{r}_{h }} = \frac{\vec{{V}_{{pc}_{•}}}}{\vec{{r}_{{inv}_{{r}_{•}}}} \cdot cos ( ϕ - {γ}_{r} )} & ( 67 ) \\ {r}_{{pp}_{h}} = {r}_{pr} \cdot \frac{{ω}_{{r}_{h}}}{{ω}_{p} } & ( 68 ) \\ \vec{{CD}_{h}} = ( {r}_{pr} - {r}_{{pp}_{h}} ) \cdot {e}^{i \cdot 0} & ( 69 ) \\ \vec{{r}_{{inv}_{{p}_{h}}}} = \vec{{r}_{{inv}_{{r}_{h}}}} - \vec{{CD}_{h}} & ( 70 )\end{matrix}$$

### Final Pinion Radii of Contact Equations

{right arrow over (Vₒ_{_{f}})}=ωᵣ_{ₒ}·r_{br}·i·e^{i·φ}^{ₚ} (71)

{right arrow over (V_{pc}_{_{f}})}=|{right arrow over (Vₒ_{_{f}})}|·e^{i·ψ} (72)

{right arrow over (P_{pc}_{_{f}})}={right arrow over (V_{pc}_{_{f}})}·t+\vec{Pₒ} (73)

{right arrow over (rᵢₙᵥ_{_{r f}})}=rᵢᵣ·e^{i·η}^{_{αf}}+{right arrow over (P_{pc}_{_{f}})} (74)

{right arrow over (rᵢₙᵥ_{_{p f}})}={right arrow over (rᵢₙᵥ_{_{r f}})}−\vec{CD} (75)

### Standard Involute Gear-Tooth Profile Equations for Mating Gear-Tooth Profiles

$$\begin{matrix}cos {ϕ}_{2} = \frac{{r}_{1} \cdot cos ( {ϕ}_{1} )}{{r}_{2}} & ( 76 ) \\ ϕ = {cos}^{- 1} ( \frac{{r}_{pp} \cdot cos ( {ϕ}_{p} )}{{r}_{inv}} ) & ( 77 ) \\ T = 2 \cdot {r}_{inv} \cdot ( \frac{{T}_{p}}{2} + inv ( {ϕ}_{p} ) - inv ( ϕ ) ) & ( 78 ) \\ {T}_{c} = 2 \cdot {r}_{inv} \cdot sin ( \frac{{T}_{p}}{2 \cdot {r}_{inv}} ) & ( 79 ) \\ X = \frac{{T}_{c}}{2} & ( 80 ) \\ Y = \sqrt{{r}_{inv}^{2} - {X}^{2}} & ( 81 )\end{matrix}$$

### Initial Involute Tooth Profile Equations

$$\begin{matrix}{ϕ}_{o} = {cos}^{- 1} ( \frac{{r}_{{pp}_{o}} \cdot cos ( {ϕ}_{p} )}{{r}_{{inv}_{o}}} ) & ( 82 ) \\ inv {ϕ}_{o} = tan ( {ϕ}_{o} ) - {ϕ}_{o} & ( 83 ) \\ {T}_{o} = 2 \cdot {r}_{{inv}_{o}} \cdot ( \frac{{T}_{p}}{2} + inv ( {ϕ}_{p} ) - inv ( {ϕ}_{o} ) ) & ( 84 ) \\ {T}_{{c}_{o}} = 2 \cdot {r}_{{inv}_{o}} \cdot sin ( \frac{{T}_{o}}{2 \cdot {r}_{{inv}_{o}}} ) & ( 85 ) \\ {X}_{o} = \frac{{T}_{{c}_{o}}}{2} & ( 86 ) \\ {Y}_{o} = \sqrt{{r}_{{inv}_{o}}^{2} - {X}_{o}^{2}} & ( 87 )\end{matrix}$$

### Hybrid Involute Profile Involute Tooth Profile Equations

$$\begin{matrix}{ϕ}_{h} = {cos}^{- 1} ( \frac{{r}_{{pp}_{h}} \cdot cos ( {ϕ}_{p} )}{{r}_{{inv}_{h}}} ) & ( 88 ) \\ inv {ϕ}_{h} = tan ( {ϕ}_{h} ) - {ϕ}_{h} & ( 89 ) \\ {T}_{h} = 2 \cdot {r}_{{inv}_{h}} \cdot ( \frac{{T}_{p}}{2} + inv ( {ϕ}_{p} ) - inv ( {ϕ}_{h} ) ) & ( 90 ) \\ {T}_{{c}_{h}} = 2 \cdot {r}_{{inv}_{h}} \cdot sin ( \frac{{T}_{h}}{2 \cdot {r}_{{inv}_{h}}} ) & ( 91 ) \\ {X}_{h} = \frac{{T}_{{c}_{h}}}{2} & ( 92 ) \\ {Y}_{h} = \sqrt{{r}_{{inv}_{h}}^{2} - {X}_{h}^{2}} + ( {r}_{{pp}_{f}} - {r}_{{pp}_{o}} ) & ( 93 )\end{matrix}$$

### Final Involute Tooth Profile Equations

$$\begin{matrix}{ϕ}_{f} = {cos}^{- 1} ( \frac{{r}_{{pp}_{f}} \cdot cos ( {ϕ}_{p} )}{{r}_{{inv}_{f} }} ) & ( 94 ) \\ inv {ϕ}_{f} = tan ( {ϕ}_{f} ) - {ϕ}_{f} & ( 95 ) \\ {T}_{f} = 2 \cdot {r}_{{inv}_{f}} \cdot ( \frac{{T}_{p}}{2} + inv ( {ϕ}_{p} ) - inv ( {ϕ}_{f} ) ) & ( 96 ) \\ {T}_{{c}_{f}} = 2 \cdot {r}_{{inv}_{f}} \cdot sin ( \frac{{T}_{f}}{2 \cdot {r}_{{inv}_{f}}} ) & ( 97 ) \\ {X}_{f} = \frac{{T}_{{c}_{f}}}{2} & ( 98 ) \\ {Y}_{f} = \sqrt{{r}_{{inv}_{f}}^{2} - {X}_{f}^{2}} & ( 99 )\end{matrix}$$

B. Nomenclature and Variables Used in Equations in Section 8(A)

CD=center distance of gearset
d=pitch diameter
dᵢₙₚᵤₜ=pitch diameter of an input gear
dₒᵤₜₚᵤₜ=pitch diameter of an output gear
Dₚ=diametral pitch

### L_{α}=Length of Approach

L_{α}_{_{f}}=length of approach at final profile
L_{α}_{ₒ}=length of approach at initial profile

### Lᵣ=Length of Recession

Lᵣ_{_{f}}=length of recession at final profile
Lᵣ_{ₒ}=length of recession at initial profile
N=number of teeth
Nₚ_{_{f}}=number of teeth of pinion gear at initial profile
Nₚ_{ₒ}=number of teeth of pinion gear at initial profile
Nᵣ=number of teeth of ring gear
O=global origin
P_{c}=circular pitch
P_{c}_{ᵢ}=current circular pitch
P_{c}_{ₒ}=initial circular pitch
P_{d}=diametral pitch
P_{d}_{ᵢ}=current diametral pitch
P_{d}_{ₒ}=initial diametral pitch
P_{pc}_{ₒ}=Initial position of the Point of Contact
R=gear ratio
r_{α}=addendum radius
r_{αp}_{_{f}}=addendum radius of pinion gear at initial profile
r_{αp}_{ₒ}=addendum radius of pinion gear at initial profile
r_{αr}=addendum radius of ring gear
r_{b}=base circle radius
r_{bp}_{_{f}}=base circle radius of pinion gear at initial profile
r_{bp}_{_{O}}=base circle radius of pinion gear at initial profile
r_{br}=base circle radius of ring gear
r_{c}=radius of curvature
r_{ic}=initial radius to point of contact along involute form
r_{ic}_{_{f}}=initial radius to point of contact along involute form at final profile
r_{ic}_{ₒ}=initial radius to point of contact along involute form at initial profile
rᵢₙ=radius of input
rᵢₙᵥ=radius to the involute form
rᵢₙᵥ_{_{f}}=pinion radius of point of contact at final profile
rᵢₙᵥ_{ₕ}=pinion radius of point of contact at hybrid profile
rᵢₙᵥ_{ₒ}=pinion radius of point of contact at initial profile
rᵢₙᵥ_{ₚ}=pinion radius of point of contact
rᵢₙᵥ_{ᵣ}=radius of the involute form of ring gear (ring radius of point of contact?)
rᵢᵣ=internal ring radius
rₒᵤₜ=radius of output
rₚ=pitch radius
rₚᵣ=pitch radius of ring gear
rₚₚ_{_{f}}=pitch radius of pinion gear at initial profile
rₚₚ_{ₕ}=pitch radius of pinion gear on hybrid
rₚₚ_{ₒ}=pitch radius of pinion gear at initial profile
T=instantaneous circular tooth thickness
T_{c}=chordal tooth thickness
T_{c}_{_{f}}=chordal tooth thickness at final profile
T_{c}_{ₕ}=chordal tooth thickness on hybrid profile
T_{c}_{ₒ}=chordal tooth thickness at initial profile
T_{f}=circular tooth thickness at final profile
Tₕ=circular tooth thickness on hybrid profile
Tₒ=circular tooth thickness at initial profile
Tₚ=circular tooth thickness at pitch radius
t=total engagement time
t_{f}=engagement time of final pinion
tₕ=engagement time of hybrid involute profile pinion
tₒ=engagement time of initial pinion

### X=Cartesian X-coordinate

X_{f}=Cartesian X-coordinate of final profile
Xₕ=Cartesian X-coordinate of hybrid profile
Xₒ=Cartesian X-coordinate of initial profile
xₚ=abscissa of the path of contact

### Y=Cartesian Y-Coordinate

Y_{f}=Cartesian Y-coordinate of final profile
Yₕ=Cartesian Y-coordinate of hybrid profile
Yₒ=Cartesian Y-coordinate of initial profile
y=ordinate of the path of contact
β=subtended arc
γᵣ=angle between \vec{rᵢₙᵥ_{ᵣ}} and the pitch point
η_{α}=angle of contact through approach
η_{α}_{_{f}}=angle of contact through approach at final profile
ηᵣ_{ₒ}=angle of contact through approach at initial profile
ηᵣ=angle of contact through recession
ηᵣ_{_{f}}=angle of contact through recession at final profile
ηᵣ_{ₒ}=angle of contact through recession at initial profile
θ=vectorial angle
θ′=vectorial angle with Y-axis at centerline of toothspace
φ=pressure angle
φ_{f}=pressure angle at final profile
φₕ=pressure angle of hybrid profile
φₒ=pressure angle at initial profile
φₚ=angle between the tangent line to the base circles of an engaged involute gearset and the line normal to the line of centers at the pitch point
ω=angular velocity
ωᵢₙ=angular velocity at input
ωₒᵤₜ=angular velocity at output
φₚ=angular velocity of pinion gear
φₚ_{_{f}}=angular velocity of pinion at final profile
φₚ_{ₒ}=angular velocity of pinion at initial profile
ωᵣ=angular velocity of ring gear
ωr_{f}=angular velocity of ring at final profile
ωrₕ=angular velocity of ring
ωᵣ_{ₒ}=angular velocity of ring at initial profile
inv φ=involute function of the pressure angle
inv φ_{f}=involute function of the pressure angle at final profile
inv φₕ=involute function of the pressure angle on hybrid profile
inv φₒ=involute function of the pressure angle at initial profile
\vec{A_{pc}}=acceleration at point of contact
\vec{CD}=center eistance of gear pair
\vec{CDₕ}=center distance of gear pear with hybrid profile
\vec{Pₒ}=initial position of the point of contact
\vec{P_{pc}}=position of the point of contact
\vec{Vₒ}=initial velocity along line of action
\vec{Vₒ_{ₒ}}=initial velocity along the line of action at initial profile
\vec{V_{pc}_{ₒ}}=initial velocity along the line of action at initial profile
\vec{ν_{f}}=final \vec{νₗₒₐ}
\vec{νᵢ}=initial \vec{νₗₒₐ}
\vec{νₗₒₐ}=velocity along the line of action
\vec{ν_{N}}=surface normal velocity normal to involute profile at point of contact
\vec{νₚ}=tangential velocity of pinion gear
\vec{νᵣ}=tangential velocity of ring gear
\vec{νₛ}=slip velocity tangent to involute profile at point of contact
\vec{νₜ}, =tangential velocity

C. Example Code for Calculating Hybrid Involute Profile

% This Matlab .m file calculates the required adjustment of radius and angle needed for the Line of Action Model

### % Required Inputs:

### % Npo Initial Pinion Number of Teeth

### % Npf Final Pinion Number of Teeth

### % Nr Ring Number of Teeth

### % DP Diametral Pitch

### % PhiG Pressure Angle at the Pitch Radius

### % Ppco Initial Position of the Point of Contact

### % Wp Angualr Velocity of the Pinion

% Tstep (n−1) Number of Time Increments
function LofA(Npo,Npf,Nr,DP,PhiG,Ppco,Wp,Tstep)

if nargin==0

Npo=12;
Npf=24;
Nr=36;
DP=3;
PhiG=22.5; %degrees
Ppco=0;
Wp=−12; %rad/sec
Tstep=99;

end

### % Standard Involutometry EQs

% Pinion (Driving) Gear
% Rpp Pitch Radius of Pinion
   Rpp_o=Npo/(2*DP)
% Rap Addendum Radius of Pinion
   Rap_o=Rpp_o+1/DP;
% Rbp Base Radius of Pinion
   Rbp_o=Rpp o*cosd(PhiG)
% Tooth Thickness at Pitch Diameter
   Tp=pi/(2*DP);
% Involute function of Global Phi (Inv_g)
   Inv_g=tan(PhiG*pi/180)-PhiG*pi/180;
% Rppf Final Pitch Radius of Pinion
   Rpp_f=Npf/(2*DP);
% Rbpf Final Base Radius of Pinion
   Rbp_f=Rpp_f*cosd(PhiG);
% Rapf Final Addendum Radius of Pinion
   Rap_f=Rpp_f+1/DP
% Ring (Driven) Gear
   % Rpr Pitch Radius of Ring
      Rpr=Nr/(2*DP);
   % Rar Addendum Radius of Ring
      Rar=Rpr+1/DP;
% Rir Inside Radius of Ring
   Rir=(Nr−1.2)/(2*DP);
% Rbr Base Radius of Ring
   Rbr=Rpr*cosd(PhiG);
% Tooth Thickness at Pitch Diameter
   Tpr=pi/(2*DP);
% Initial Angular Velocity of Ring (Wr_o)<
   Wr_o=Wp*Rpp_o/Rpr;
% Final Angular Velocity of Ring (Wr_f)
   Wr_f=Wp*Rpp_f/Rpr;
      % Angle from points of contact of Intitial Pinion w/ respect to the Ring

% Angle to first point of contact (Eta)
% Length along Line of Action (Arc Length of Engagement)
La_o=Rpr*sind(PhiG)−sqrt(Rir̂2−Rbr̂2);

EtaA_o=acos((−La_ô2+Rir̂2+Rpr̂2)/(2*Rir*Rpr));

% Angle to Final point of contact (EtaA)
% Length along Line of Action (Arc Length of Engagement)
Lr_o=sqrt(Rap_ô 2−Rbp_ô2)−Rpp_o*sind(PhiG);
Rco=sqrt(Rpr̂2+Lr_ô2−2*Rpr*Lr_o*cosd(PhiG+90));

EtaR_o=acos((—Lr_ô2+Rcô2+Rpr̂2)/(2*Rco*Rpr));

% Angle from points of contact of Final Pinion

% Angle to first point of contact (Eta)
% Length along Line of Action (Arc Length of Engagement)
La_f=Rpr*sind(PhiG)−sqrt(Rir̂2−Rbr̂2);

EtaA_f=acos((−La_f̂2+Rir2+Rpr̂2)/(2*Rir*Rpr));

% Angle to Final point of contact (EtaA)
% Length along Line of Action (Arc Length of Engagement)
Lr_f=sqrt(Rap_f̂2−Rbp_f̂2)+(Rpr−Rpp_f)*sind(PhiG)−Rpr*sind(PhiG);
Rcf=sqrt(Rpr̂2+Lr_f̂2−2*Rpr*Lr_f*cosd(PhiG+90));

EtaR_f=acos((−Lr_f̂2+Rcf̂2+Rpr̂2)/(2*Rcf*Rpr));

### % Time Array of Initial Pinion

Tfinal_o=(La_o+Lr_o)/(abs(Wr_o)*Rbr); % (EtaA_o+EtaR_o)/abs(Wr_o)

t_o=[0:Tfinal_o/Tstep:Tfinal_o]′; % sec

### % Time Array of Hybrid Pinion

% Intitial Guesses of Apc and Tfinal_c
Apc=500; % Raidans/ŝ2
Tfinal_c=0.02; % sec

Time=[Apc, Tfinal_c]; % Radians

% Function to find values of ThetaInm and Thetam
[Time,fval]=fsolve(@MFunc,Time[ ],La_o, Lr_f, Rbp_o, Rbp_f, Wp, Ppco);

% Position of Input
Apc=Time(1);

% Position of Output
Tfinal_c=abs(Time(2));

t_c=[0:Tfinal_c/Tstep:Tfinal_c]′; % sec

### % Time Array of Final Pinion

Tfinal_f(La_f+Lr_f)/(abs(Wr_f)*Rbr);% (EtaA_f+EtaR_f)/abs(Wr_f)

t_f=[0:Tfinal_f/Tstep:Tfinal_f]′; % sec

### % Psi

Psi=(PhiG−90)*pi/180; % rad

### % PhiG in Radians

PhiG=PhiG*pi/180; % rad

### % Initial Tooth Profile Radius of Contact (Ri_o)

% Initial Contact Velocity Vo
   Vo_o=Wr_o*Rbr*i*exp(i*PhiG); % in/sec
% Velocity of the point of contact
   Vpc_o=(abs(Vo_o)).*exp(i*Psi); % in/sec
% Position of the Point of Contact (Ppc)
   Ppc_o=(abs(Vo_o).*t_o+Ppco).*exp(i*Psi); % in
% Radius of Contact Point on Ring (Rcr)
   Rcr_o=Rir*exp(i*EtaA_o)+Ppc_o; % in
% Center Distance (CD)
   CD_o=(Rpr−Rpp_o).*exp(i*0);
% Radius of Pinion at Point of Contact (Ri_o)
Ri_o=Rcr_o−CD_o;

% Eqs to determine Initial Involute profile (Ri_o)
% Pressure Angle
   Phi_o=acos(Rpp_o.*cos(PhiG)./abs(Ri_o));
% Involute Function of Phi (Inv_i)
   Invo=tan(Phi_o)−Phi_o;
% Arc Length of Tooth (T_i)
   T_o=2.*abs(Ri_o).*(Tp./(2.*Rpp_o)+Inv_g−Inv_o);
% Chordal Tooth Thickness
   Tc_o=2.*abs(Ri_o).*sin(T_o./(2.*abs(Ri_o)));

% X Coordinate

X_o=Tc_o./2;

% Y Coordinate

Y_o=sqrt(abs(Ri_o). ̂2−X_o. ̂2);

% Path of Contact (Ri_o)
Xp_o=abs(Ri_o).*sin(Phi_o−PhiG);
Yp_o=Rpp_o−abs(Ri_o).*cos(Phi_o−PhiG);

% Slope of the Path of Contact

PCslope_o=polyfit(Xp_o,Yp_o,1)

### % Hybrid Tooth

% Initial Contact Velocity Vo
Vo_c=Wr_o*Rbr*i*exp(i*PhiG); % in/sec
MagVo=abs(Vo_c);
AngVo=angle(Vo_c);

% Velocity of the point of contact
Vpc_c=(Apc.*t_c+abs(Vo_c)).*exp(i*Psi); % in/sec

% Position of the Point of Contact (Ppc)
Ppc_c=(Apc/2.*t_c. ̂2+abs(Vo_c).*t_c+Ppco).*exp(i*Psi); % in

% Radius of Contact Point on Ring (Rcr)
Rcrc=Rir*exp(i*EtaA_o)+Ppc_c; % in

% Angle between Rcr and Pitch Point (GammaR)
GammaR=angle(Rcrc); % rad

% Angular Velocity of Ring (Wr)
Wr_c=abs(Vpc_c)./(abs(Rcr_c).*cos(PhiG−GammaR));% rad/sec

% Contact Velocity of Ring
Vcr_c=abs(Rcr_c).*cos(PhiG−GammaR).*exp(i*(Psi)).*Wr_c;% in/sec
MagVcr=abs(Vcr_c);
AngVcr=angle(Vcr_c)*180/pi;

% Fundamental Law of Gearing (Rpp_fl)
Rpp_c=abs(Rpr.*Wr_c/Wp);

% Center Distance (CD)
CDc=(Rpr−Rpp_c).*exp(i*0);

% Radius of Pinion at Point of Contact (Rip) 8H B^{Ri}_c=Ri_c=Rcr_c−CD_c;

% Angle between Rep and Pitch Point (GammaP)
GammaP=angle(Ri_c);

% Velocity of the Point of Contact on the Pinion Vcp
Vcp=abs(Ri_c).*abs(Wp).*cos(PhiG−GammaP).*exp(i*Psi);
RipMag=abs(Ri_c);

% Eqs to determine the Involute profile
% Pressure Angle
   Phi_c=acos(Rpp_c.*cos(PhiG)./abs(Ri_c));

% Involute Function of Phi (Inv_i)
Inv_c=tan(Phi_c)−Phi_c;

% Arc Length of Tooth (T_i)
T_c=2.*abs(Ri_c).*(Tp./(2.*Rpp_c)+Inv_g−Inv_c);

% Chordal Tooth Thickness
Tc_c=2.*abs(Ri_c).*sin(T_c./(2.*abs(Ri_c)));

% X Coordinate
X_c=Tc_c./2;

% Y Coordinate
Y_c=sqrt(abs(Ri_c). ̂2−X_c. ̂2);

### % Path of Contact (Ri_o)

Xp_c=abs(Ri_c).*sin(Phi_c−PhiG);
Yp_c=Rpp_c−abs(Ri_c).*cos(Phi_c−PhiG);
PCslope_c=polyfit(Xp_c,Yp_c,1)
Growth=polyfit(abs(Rpp_c),abs(Ri_c),1)

### % Final Tooth Profile Radius of Contact (Ri_f)

% Initial Contact Velocity Vo
Vo_f=Wr_f*Rbr*i*exp(i*PhiG); % in/sec

% Velocity of the point of contact
Vpc_f=(abs(Vo_f)).*exp(i*Psi); % in/sec

% Position of the Point of Contact (Ppc)
Ppc_f=(abs(Vo_f).*t_f+Ppco).*exp(i*Psi); % in

% Radius of Contact Point on Ring (Rcr)
Rcr_f=Rir*exp(i*EtaA_f)+Ppc_f; % in

% Center Distance (CD)
CD_f=(Rpr−Rpp_f).*exp(i*0);

Radius of Pinion at Point of Contact (Rip)
Ri_f=Rcr_f−CD_f;

% Eqs to determine Initial Involute profile
% Pressure Angle
   Phi_f=acos(Rpp_f.*cos(PhiG)./abs(Ri_f));
% Involute Function of Phi (Inv_i)
   Inv_f=tan(Phi_f)−Phi_f;
% Arc Length of Tooth (T_i)
   T_f=2.*abs(Ri_f).*(Tp./(2.*Rpp_f)+Inv_g−Inv_f);
% Chordal Tooth Thickness
   Tc_f=2.*abs(Ri_f).*sin(T_f./(2.*abs(Ri_f)));
% X Coordinate
   X_f=Tc_f./2;
% Y Coordinate
   Y_f=sqrt(abs(Ri_f). ̂2−X_f. ̂2);

% Path of Contact (Ri_o)
Xp_f=abs(Ri_f).*sin(Phi_f−PhiG);
Yp_f=Rpp_f−abs(Ri_f).*cos(Phi_f−PhiG);
PCslope_f=polyfit(Xp_f,Yp_f,1)

### % Plots of Involute Curves

figure(1)
subplot(221)
plot(Tc_f,t_f,‘r’,Tc_o,t_o,‘g’,Tc_c,t_c,‘b’)
grid;
axis ([−0.65.65-0.01.07])
xlabel(‘Tc’);
ylabel(‘Time’);
title(‘Chordal Length vs Time’);
legend(‘Final’,‘Initial’,‘Hybrid’,‘location’,‘SouthOutside’)
subplot(222)
plot(Tc_f,abs(Rif),‘r’,Tc_o, abs(Ri_o),‘g’,Tc_c,abs(Ri_c),‘b’)=
grid;
axis ([−2.5 2.5 1.75 4.35])
xlabel(‘Tc’);
ylabel(‘Ri’);
title(‘Chordal Length vs Ri’);
legend(‘Final’,‘Initial’,‘Hybrid’,‘location’,‘SouthOutside’)
subplot(223)
plot(X_o,Y_o+(Rpp_f−Rpp_o),‘g’,−X_o,Y_o+(Rpp_f−Rpp_o),‘g’,X_f,Y_f,‘r’,−X_f,Y_f,‘r’,Xc,Y_c+(Rpp_f−Rpp_c),‘b’,−X_c,Y_c+(Rpp_f−Rpp_c),‘b’);
axis ([−0.35.35 3.75 4.35])
grid;
xlabel(‘X’);
ylabel(‘Y’);
title(‘Involute Profiles’);
subplot(224)
plot(Xp_f, Yp_f,‘r’,Xp_o,Yp_o,‘g’,Xp_c,Yp_c,‘b’)
grid;
xlabel(‘Xp’);
ylabel(‘Yp’);
title(‘Path of Contact’);
figure (2)
plot(X_o,Y_o+(Rpp_f−Rpp_o),‘g’,−X_o,Y_o+(Rpp_f−Rpp_o),‘g’,X_f,Y_f,‘r’,−X_f,Y_f,‘r’,X_c,Y_c+(Rpp_f−Rpp_c),‘b’,−X_c,Y_c+(Rpp_f−Rpp_c),‘b’);
axis ([−0.35.35 3.75 4.35])
grid;
xlabel(‘X’);
ylabel(‘Y’);
title(‘Involute Profiles’);
% legend(‘Initial’,‘Initial’,‘Hybrid’,‘Hybrid’,‘Final’,‘Final’,‘location’,‘SouthOutside’)
figure (3)
plot(Xp_o,Yp_o,‘g’,Xp_c,Yp_c,‘b’,Xp_f,Yp_f,‘r’)
grid;
xlabel(‘Xp’);
ylabel(‘Yp’);
title(‘Path of Contact’);
% legend(‘Initial’,‘Hybrid’,‘Final’,‘location’,‘SouthOutside’)
% Function used for Fsolve of BCIm

function Time_c=MFunc(Time, La_o, Lr_f, Rbp_o, Rbp_f, Wp, Ppco);

% Prep Equations

Apc=Time(1);

Tfinal_c=Time(2);

Ppc=La_o+Lr_f;

Vo=Wp*Rbp_o;

Vf=Wp*Rbp_f;

% System of Equations

Time_c=[Vf-Apc*Tfinal_c−Vo,Ppc−Apc*Tfinal_ĉ2/2−Vo*Tfinal_c-Ppco];

What is claimed is:

1. A power transfer system, comprising:
A power input mechanism;
a phase shifting mechanism coupled to the power input mechanism, wherein the phase shifting mechanism includes:
at least two members configured to provide respective reciprocating inputs; and
a combiner configured to combine the at least two reciprocating inputs into an aggregate output; and
an output system coupled to the phase shifting mechanism and configured and arranged to receive the aggregate output from the phase shifting mechanism.

2. The power transfer system of claim 2, wherein the at least two reciprocating inputs include at least one eccentric gear.

3. The power transfer system of claim 3, wherein the at least one eccentric gear has one or more teeth with a hybrid involute tooth profile.

4. The power transfer system of claim 3, wherein the eccentric gear has a varying base circle radius, and wherein the hybrid involute tooth profile is described by the following:
$${X}_{h} = \frac{{T}_{{c}_{h}}}{2} ; and$$
$${Y}_{h} = \sqrt{{r}_{{inv}_{h}}^{2} - {X}_{h}^{2}} + ( {r}_{{p}_{f}} - {r}_{{p}_{o}} ) ,$$
wherein Xₕ and Yₕ are Cartesian X and Y coordinates respectively, and wherein:
T_{ch} is a chordal tooth thickness on the hybrid involute tooth profile;
rᵢₙᵥₕ is a radius of a point of contact on the hybrid involute tooth profile;
r_{pf} is a pitch radius at an initial profile; and
rₚₒ is a pitch radius at a final profile.

5. The power transfer system of claim 4, wherein the initial profile corresponds to a first base circle radius, and the final profile corresponds to a second base circle radius, the first and second base circle radii being different.

6. The power transfer system of claim 1, wherein the phase shifting mechanism further includes:
at least one variable phase component operably connected to the combiner, wherein the variable phase component is configured to selectively change a reciprocating input received from one or more of the at least two reciprocating inputs.

7. The power transfer system of claim 1, wherein the phase shifting mechanism is a first phase shifting mechanism, and the power transfer system further including:
a second phase shifting mechanism configured to provide at least two reciprocating inputs; and
a combiner configured to combine the at least two reciprocating inputs into an aggregate output.

8. The power transfer system of claim 1, wherein the output system comprises:
a first drive shaft having a first drive gear;
a second drive shaft having a second drive gear; and
an output shaft having one or more driveable gears.

9. The power transfer system of claim 8, wherein the first drive gear and second drive gear define different respective gear ratios relative to the one or more driveable gears.

10. The power transfer system of claim 9, further comprising:
a synchronization mechanism, wherein the synchronization mechanism adjusts a speed of one or both of the first and second drive shafts, and wherein the synchronization mechanism is configured to:
selectively engage the first drive gear at a first gear ratio;
selectively engage the second drive gear at a second gear ratio; and
selectively engage both the first and second drive gears at a third ratio between the first and second gear ratios.

11. The power transfer system of claim 1, further comprising:
a reverse differential coupled to the power input mechanism and the output system.

12. The power transfer system of claim 11, wherein the reverse differential is configured to combine an input from the power input mechanism with an output from the output system to produce a final output.

13. The power transfer system of claim 12, wherein the reverse differential is configured to receive one or more combinations of the input from the power input mechanism and the output from the output system which produce a final output that is an engaged neutral, in which:
the input from the power input mechanism is offset by the output from the output system; and
the final output has approximately zero rotation.

14. A power transfer system, comprising:
an input mechanism;
an output having one or more driveable gears;
a gear selection mechanism coupled to the input and output, and disposed between the input and the output, wherein the gear selection mechanism includes:
a plurality of drive gears configured to engage the one or more driven gears of the output, wherein the one or more drive gears are substantially coaxial, and wherein each of the plurality of drive gears are in substantially constant mesh with the one or more driven gears; and
a gear selector that causes a single one of the plurality of drive gears to selectively engage one of the one or more driveable gears.

15. The power transfer system of claim 14, wherein the gear selector includes:
a set of one or more balls internal to each of the plurality of drive gears; and
one or more pockets formed on the plurality of drive gears, each of the one or more pockets being configured to engage one or more corresponding balls.

16. The power transfer system of claim 14, wherein the plurality of drive gears are on a common drive shaft, and wherein the gear selector is configured to cause the single one of the plurality of drive gears to selectively engage the one or more driveable gears by way of a mechanism internal to the drive shaft and the single one of the plurality of drive gears.

17. The power transfer system of claim 16, wherein the mechanism internal to the drive shaft includes:
a trap shaft having a plurality of balls and defining a channel therein, the channel being configured to house a fluid; and
a pressurization mechanism configured to pressurize the fluid within the channel defined by the trap shaft, wherein the fluid, when under pressure, exerts a force to cause the plurality of balls to selectively engage only one of the plurality of drive gears.

18. The power transfer system of claim 14, wherein the gear selector has a rotatable shaft that is configured to selectively engage the single one of the plurality of drive gears, wherein any rotational position of the rotatable shaft is configured to cause the rotatable shaft to selectively engage at most one of the plurality of drive gears.

19. A gear, comprising:
a gear body; and
a plurality of teeth disposed around at least a portion of the gear body, wherein at least two teeth of the plurality of teeth have different respective profiles.

20. The gear of claim 19, wherein the at least two teeth having different respective profiles includes:
a first tooth having a profile corresponding to at least a first base circle radius;
a second tooth having a profile corresponding to at least a second base circle radius, wherein the second base circle radius is different than the first base circle radius.

21. The gear of claim 19, wherein at least one of the plurality of teeth has a hybrid involute tooth profile, wherein the hybrid involute tooth profile:
has a base width corresponding to an initial profile of a first base circle radius; and
has a top width corresponding to a final profile of a second base circle radius that is different than the first base circle radius.
